(19) United States
(12) Patent Application Publication
(10) Pub. No.: US 2026/0017035 A1
(43) Pub. Date: Jan. 15, 2026

(54) INTERACTIVE WORKFLOW GRAPHICAL ANALYSIS

(71) Applicant: Palantir Technologies Inc., Denver, CO (US)

(72) Inventors: Parvathy Menon, San Jose, CA (US); Kamran Khan, London (GB); Joseph Rafidi, Mountain View, CA (US)

(21) Appl. No.: 18/940,627

(22) Filed: Nov. 7, 2024

Related U.S. Application Data
(60) Provisional application No. 63/669,511, filed on Jul. 10, 2024.

(51) Int. Cl. G06F 8/38

(52) U.S. Cl. CPC G06F 8/38

(57) ABSTRACT

Computer-implemented systems and methods are disclosed, including systems and methods utilizing language models for generating interactive workflow graphical user interfaces. A computer-implemented method may include: accessing one or more data stores that store a configuration of a software application; determining, based on the configuration of the software application, that first one or more actions and first one or more data object types are associated with the software application; based at least on the first one or more actions and the first one or more data object types associated with the software application, generating an interactive graphical representation comprising a first node representing the software application, a first user interface element of the first node, and a second user interface element of the first node.

### CROSS-REFERENCE TO RELATED APPLICATIONS

This application claims benefit of U.S. Provisional Patent Application No. 63/669,511, filed Jul. 10, 2024, and titled “INTERACTIVE WORKFLOW GRAPHICAL ANALYSIS.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for data integration, analysis, and visualization. More specifically, some embodiments of the present disclosure relate to interactive graphs including nodes and edges for representing data objects, actions, and/or software applications.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computers can be programmed to perform calculations and operations utilizing one or more software-based workflows or applications. For example, a software application can facilitate systematic organization and automation of tasks and processes on computing systems, and may streamline operations and enhance efficiency in the execution of tasks and processes. Once created or deployed, the software application may be operated, and/or updated to accomplish certain user objectives.

### SUMMARY

The systems, methods, and devices described herein each have several aspects, no single one of which is solely responsible for its desirable attributes. Without limiting the scope of this disclosure, several non-limiting features will now be described briefly.

Software-based workflows or applications can facilitate systematic organization and automation of tasks and processes on computing systems, and may streamline operations and enhance efficiency in the execution of tasks and processes. Once created or deployed, a workflow or a software application may be operated, and/or updated to accomplish certain user objectives. However, it can be inefficient to manage a software application that may be continually operated by user(s). For example, currently there may be no efficient way for a user to understand relationships (e.g., data dependencies, lineage, or provenance) between components (e.g., data objects, actions, functions, logics) of a software application as the software application continues to be operated or updated by one or more users. Further, it may be desirable to implement finer level (e.g., component level) of granularity for managing and analyzing various components of a software application based on various criteria (e.g., permission of a user, an ontology associated with the software application).

The present disclosure describes systems and methods (generally collectively referred to herein as a “workflow visualization system” or simply a “system”) that can advantageously overcome various of the technical challenges mentioned above, among other technical challenges. More specifically, various implementations of the systems and methods of the present disclosure can advantageously utilize interactive visualization (e.g., generation of graphical representations including nodes and edges to represent data objects, actions, and/or software applications), data analysis, data processing, and/or machine learning techniques to allow users to efficiently manage and/or understand relationships between components (e.g., data objects, actions, functions, logics, and/or the like) associated with one or more software applications. Advantageously, the system may provide improvements to user interfaces through providing interactive node graphs to provide interactive graphical analysis of dependencies, relationships, and interactions among components of software applications or software-based workflows. Further, based on permissions of users and an ontology associated with a software application, the system may provide various levels of granularity (e.g., permitting a user to edit a data object using a software application but preventing the user from execute an action using the software application) for managing (e.g., executing, maintaining, debugging, or the like) and analyzing the various components of the software application.

Various embodiments of the present disclosure provide improvements to various technologies and technological fields. For example, as described above, the system may advantageously utilize interactive visualization, data analysis, data processing, and/or machine learning techniques to provide interactive analysis of one or more software applications. Other technical benefits provided by various embodiments of the present disclosure include, for example, providing various levels of granularity for managing and analyzing the various components of the software application based on permissions of users and/or an ontology associated with the software application.

Additionally, various implementations of the present disclosure are inextricably tied to computer technology. In particular, various implementations rely on detection of user inputs via graphical user interfaces, calculation of updates to displayed electronic data based on those user inputs, automatic processing of related electronic data, application of language models and/or other artificial intelligence, and provision of the updates to displayed information via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various implementations cannot reasonably be performed by humans alone, without the computer technology upon which they are implemented. Further, the implementation of the various implementations of the present disclosure via computer technology enables many of the advantages described herein.

According to various implementations, large amounts of data may be automatically and dynamically processed interactively in response to user inputs, and the processed data is efficiently and compactly presented to a user through interactive user interfaces of the system. Thus, in some implementations, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The present disclosure describes various implementations of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface via the inputs described herein may provide an optimized display of, and interaction with, models and model-related data, and may enable a user to more quickly and accurately access, navigate, assess, and digest the model-related data than previous systems.

Further, the interactive and dynamic user interfaces described herein are enabled by innovations in efficient interactions between the user interfaces and underlying systems and components. For example, disclosed herein are improved methods that utilize interactive visualization, data analysis, data processing, and/or machine learning techniques to provide interactive analysis of one or more software applications. More specifically, the system may generate graphical representations including nodes and edges to represent data objects, actions, software applications and indicate relationships, dependencies, lineage between data objects, actions, functions, and/or logics associated with one or more software applications. According to various implementations, the system (and related processes, functionality, and interactive graphical user interfaces) can advantageously provide various levels of granularity (e.g., permitting a user to edit a data object using a software application but preventing the user from executing an action using the software application) for managing (e.g., executing, maintaining, debugging, or the like) and analyzing the various components of the software application based on permissions of users and/or an ontology associated with a software application.

Thus, various implementations of the present disclosure can provide improvements to various technologies and technological fields, and practical applications of various technological features and advancements. For example, as described above, existing software application management and integration technology is limited in various ways, and various implementations of the disclosure provide significant technical improvements over such technology. Additionally, various implementations of the present disclosure are inextricably tied to computer technology. In particular, various implementations rely on operation of technical computer systems and electronic data stores, automatic processing of electronic data, and the like. Such features and others (e.g., automatically generating machine learning models to fulfill specific user requests, processing and analysis of large amounts of electronic data, management of data migrations and integrations, and/or the like) are intimately tied to, and enabled by, computer technology, and would not exist except for computer technology. Further, the implementation of the various implementations of the present disclosure via computer technology enables many of the advantages described herein, including more efficient management of various types of electronic data (including computer-based models).

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums having program instructions embodied therewith, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums are disclosed, wherein the computer-readable storage medium(s) have program instructions embodied therewith, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a block diagram illustrating an example workflow visualization system in an example computing environment, according to various implementations of the present disclosure;

FIG. 2 shows an example block diagram of example aspects of the workflow visualization system, according to various embodiments of the present disclosure;

FIG. 3 illustrates an object-centric conceptual data model, according to various embodiments of the present disclosure;

FIG. 4 is a block diagram illustrating an example log data object, according to various embodiments of the present disclosure;

FIG. 5 is a flowchart illustrating example routines for generating interactive graphical representations to represent data object types and actions associated with a software application, according to various embodiments of the present disclosure;

FIGS. 6A and 6B are flowcharts illustrating example routines for determining actions and data object types associated with a software application, according to various implementations of the present disclosure;

FIG. 7 is a flowchart illustrating example routines for providing a split view including a graphical representation associated with a software application and the software application, according to various implementations of the present disclosure;

FIGS. 8, 9, 10, 11, 12, and 13 show example interactive graphical user interfaces associated with the workflow visualization system, according to various implementations of the present disclosure; and

FIG. 14 is a block diagram of an example computer system consistent with various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

As mentioned above, software-based workflows or applications can facilitate systematic organization and automation of tasks and processes on computing systems, and may streamline operations and enhance efficiency in the execution of tasks and processes. Once created or deployed, a workflow or a software application may be operated, and/or updated to accomplish certain user objectives. However, it can be inefficient to manage a software application that may be continually operated by user(s). For example, currently there may be no efficient way for a user to understand relationships (e.g., data dependencies, lineage, or provenance) between components (e.g., data objects, actions, functions, logics) of a software application as the software application continues to be operated or updated by one or more users. Further, it may be desirable to implement finer level (e.g., component level) of granularity for managing and analyzing the various components of a software application based on various criteria (e.g., permission of a user, an ontology associated with the software application).

As also noted above, the present disclosure describes systems and methods (generally collectively referred to herein as a “workflow visualization system” or simply a “system”) that can advantageously overcome various of the technical challenges mentioned above, among other technical challenges. More specifically, various implementations of the systems and methods of the present disclosure can advantageously utilize interactive visualization (e.g., generation of graphical representations including nodes and edges to represent data objects, actions, and/or software applications), data analysis, data processing, and/or machine learning techniques to allow users to efficiently manage and/or understand relationships between components (e.g., data objects, actions, functions, logics, and/or the like) associated with one or more software applications.

Advantageously, the system may provide improvements to user interfaces through providing interactive node graphs to provide interactive graphical analysis of dependencies, relationships, and interactions among components of software applications or software-based workflows in compact and dynamic manners. Further, based on permissions of users and an ontology associated with a software application, the system may provide various levels of granularity (e.g., permitting a user to edit a data object using a software application but preventing the user from execute an action using the software application) for managing (e.g., executing, maintaining, debugging, or the like) and analyzing the various components of the software application.

### Example Features Related to Interactive Node Graph Generation

As noted above, the system may generate interactive node graph or graphical representations comprising nodes and edges to provide interactive visualizations of data dependencies and relationships between components of a software application or a software-based workflow in compact and dynamic manners. For example, the system can access one or more data stores that store a configuration of a software application. The configuration of the software application may include information used for configuring the software application, such as widgets (e.g., a button, a tab with which users can interact), code (e.g., Python code), variables, and/or functions used to configure the software application. In some implementations, the configuration of the software application can be stored using a JavaScript Object Notation (“JSON”) format to define or describe the information (e.g., widgets, code, variables, and/or functions) and relationships (e.g., dependencies, lineage, or provenance) among the information used for configuring the software application. The system may access and parse the configuration to determine or identify actions (e.g., send an email, unsend an email, edit a document, or the like), data object types (e.g., an email data object type, a document data object type, or the like) that are associated with the software application.

More specifically, the system may access the configuration to extract the widgets, the code, the variables, and/or the functions along with relationships of the information for configuring the software application. Based on the extraction and/or the relationships, the system may parse or traverse at least the widgets, the code, the variables, and/or the functions to determine that one or more actions and one or more data object types are referenced or used by the widgets, the code, the variables, and/or the functions, and the one or more actions and the one or more data object types are associated with the software application. By parsing and/or traversing the information included in the configuration, the system may also determine lineage or provenance among the one or more actions, the one or more data object types, and the software application.

In some implementations, the system may utilize a data processing service (e.g., a similarity search service) and/or an ontology to parse the widgets, the code, the variables, or the functions to identify the one or more actions, the one or more data object types, and the lineage among the one or more actions, the one or more data object types, and the software application. For example, the code of the software application may refer to an identification number of a data object type without further identifying the data object type. By utilizing the ontology to parse the code, the system may identify additional information (e.g., properties of the data object type, links between the data object type and other data object types) about the data object type, and include the additional information in an interactive node graph to be generated. Advantageously, the ontology may be helpful for the system to identify relationships, properties, and/or links between data object types and understand the overall structure of the software application.

Based at least on the one or more actions and one or more data object types identified from parsing or traversing the configuration, the system may generate an interactive graphical representation. The interactive graphical representation may include nodes and edges, where nodes represent the one or more actions, the one or more data object types, and/or the software application. Edges may represent the relationships and dependencies between the nodes to indicate lineage or provenance among the one or more actions, the one or more data object types, and the software application determined based on the configuration. For example, an edge may be directed from a node representing a data object type (e.g., a team member data object type) to another node representing the software application (e.g., email review) to indicate that the software application reads a data object of the data object type. As another example, an edge may be directed from a node representing an action (e.g., send email) to another node representing a data object type (e.g., an email data object type) to indicate that the action edits a data object of the data object type.

In some implementations, node(s) in the interactive graphical representation may include user interface elements (e.g., icon, button, or the like) that indicate and/or provide additional information about a data object type, an action, or a software application represented by the node(s). For example, a node representing a software application may include a first user interface element indicating that the one or more data object types are associated with the software application. The node may further include a second user interface element indicating that the one or more actions are associated with the software application. Advantageously, these user interface elements may allow users to quickly identify actions and data object types that are associated with a software application.

The system may allow users to interact with the interactive graphical representation by making selections on nodes, edges, and/or user interface elements associated with the nodes. For example, selecting a user interface element of a node (e.g., the user interface element represents one or more actions associated with a software application that is represented by the node) may trigger the display of additional nodes and/or edges, which may represent further details or information (e.g., other software applications associated with the one or more actions, data object types associated with the one or more actions) about the one or more actions. Such interaction between the interactive graphical representation may enable users to explore and understand the relationships and dependencies within the software application in an efficient, dynamic and intuitive manner. Additionally, displaying additional details through the interactive graphical representation in response to user interactions (e.g., selecting specific nodes) is conducive to allow the system to provide compact and efficient visualization, thereby improving the layout and display of nodes and edges to ensure that the interactive graphical representation is easy for users to navigate and understand.

Additionally and/or optionally, the interactive graphical representation may further include one or more nodes that represent log data objects of a log data object type associated with a software application. For example, a node representing an action log that records at least a timestamp and user identity associated with performance of an action may be displayed through the interactive graphical representation in response to a user operation (e.g., select, click, or the like) on another node representing the action. In some implementations, responsive to a selection on the node representing the action log, the timestamp and user identity associated with performance of the action may be display through a bottom pane or a left pane of a user interface that includes the interactive graphical representation. Advantageously, the action log may allow users to view and analyze the history of actions and/or their impact on the software application, which may be particularly useful for debugging and maintaining the software application.

### Example Features Related to Graph and Function Views of Applications

Besides displaying an interactive graphical representation that includes node(s) and/or edge(s) representing actions and data object types associated with a software application, the system may additionally and/or optionally provide a split-screen mode where the interactive graphical representation is displayed adjacent to the software application itself (e.g., a user interface of the software application that allows users to operate the software application). This split-screen mode may enhance a user's ability to understand and manage the relationships and dependencies within the software application. The split-screen mode may juxtapose the interactive graphical representation with the software application to allow users to simultaneously view and/or manage the interactive graphical representation of the actions and data object types associated with the software application and the actual software application interface. Advantageously, the split-screen mode provides a comprehensive view, enabling users to correlate the visual representation with the functional aspects of the software application.

In some implementations, the split-screen mode may be entered in response to a user operation on a node of the interactive graphical representation that represents the software application, thereby displaying the interactive graphical representation and the software application. When a user selects a functional component (e.g., a button, a tab, an article, a icon) within the software application, the corresponding node in the interactive graphical representation may be highlighted. For example, when a user selects an email in the software application, a corresponding node in the interactive graphical representation that represents an email data object type may be highlighted. Conversely, in some implementations, selecting a node in the interactive graphical representation highlights a corresponding functional component in the software application. This unidirectional and/or bidirectional highlighting helps users quickly identify and understand the connections between the software application's functional components and their corresponding graphical representations.

Advantageously, the split-screen mode may facilitate efficient navigation between the interactive graphical representation associated with the software application and the software application. Users can easily switch between exploring the interactive graphical representation and interacting with the software to seamlessly navigate and efficiently manage the software application. The split-screen mode may also be useful for debugging and maintaining the software application. By juxtaposing the interactive graphical representation and the software application, users may quickly identify issues and analyze dependencies to efficiently manage or update the software application.

### Example Features Related to Granular Permissions

The system may allow granular permissions for providing fine-grained control over user access and actions within a software application to ensure that users have appropriate levels of access and/or execution based on user permissions (e.g., dependent upon their roles, responsibilities in an organization, and/or the context of their interactions with the application), and/or other criteria. As such, a user may be able to view more, access more, and/or perform more operations associated with an interactive graphical representation compared with another user, depending on user permissions. Additionally and/or optionally, scope of information associated with the software application included in an interactive graphical representation may be dependent upon an ontology associated with the software application.

The system may define permissions at different levels of granularity, ranging from broad access to specific, fine-grained control. For example, a user may have permission to access a data object type but may be restricted from performing certain actions on the data object type. Advantageously, this scope of permissions ensures that users have access only to the data object types and actions based on their permissions. In some implementations, the interactive graphical representation may include a coloration scheme that visually distinguishes nodes and edges based on user permissions. For example, nodes representing data object types or actions that a user can access or perform may be colored differently from those that the user cannot access or perform. This visual differentiation helps users quickly understand their access levels and navigate the application accordingly. In some implementations, the system may utilize coloration scheme or other visual distinguishment techniques to differentiate between permissions to execute actions, and permissions to edit data objects. For example, the interactive graphical representation may indicate (e.g., through a coloration scheme) that a user may be permitted to execute an action (e.g., send an email) but may not have permission to edit a data object (e.g., the email content) to ensure that users can perform necessary actions without compromising the integrity of the data.

### Example Features Related to User Interfaces

The system may further allow user to interact with the system through a user interface (e.g., a graphical user interface (“GUI”) or other types of user interfaces), and receive user operations on an interactive graphical representation that is presented through the user interface. As noted above, the system may use one or more user interfaces to present the interactive graphical representation associated with a software application, and the software application itself. The user interface may allow users to make selections on nodes, edges, and user interface elements within the interactive graphical representation. For example, selecting a node representing a data object type may trigger the display of additional nodes and edges, providing further details about the data object type through the user interface.

Besides providing the interactive graphical representation and/or the software application through one or more user interfaces, the system may utilize a user interface to provide information panel(s) adjacent to the interactive graphical representation and/or the software application. In some implementations, the information panel(s) may include information to assist users to more efficiently manage the software application. For example, as noted above, a user interface may include an action log that records actions performed within the software application. The action log can be displayed through a bottom pane or a left pane of the user interface, allowing users to view and analyze the history of actions and their impact on the software application's components. As another example, the system can use a large language model (“LLM”) to generate a natural language summary of a function code used to implement actions within the software application. The summary may be displayed in a summary panel via the user interface, providing users with a concise and understandable overview of the function code.

### Further Example Information Related to Various Implementations

To facilitate an understanding of the systems and methods discussed herein, several terms are described below and herein. These terms, as well as other terms used herein, should be construed to include the provided descriptions, the ordinary and customary meanings of the terms, and/or any other implied meaning for the respective terms, wherein such construction is consistent with context of the term. Thus, the descriptions below and herein do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like. A “nondeterministic model” as used in the present disclosure, is any model in which the output of the model is not determined solely based on an input to the model. Examples of nondeterministic models include language models such as LLMs, ML models, and the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, attention-based and/or transformer architecture or functionality. LLMs can be useful for natural language processing, including receiving natural language prompts and providing natural language responses based on the text on which the model is trained. LLMs may not be data security- or data permissions-aware, however, because they generally do not retain permissions information associated with the text upon which they are trained. Thus, responses provided by LLMs are typically not limited to any particular permissions-based portion of the model.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, language model, or LLM, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), and BigScience Large Open-science Open-access Multilingual Language Model (BLOOM).

A Prompt (or “Natural Language Prompt” or “Model Input”) can be, for example, a term, phrase, question, and/or statement written in a human language (e.g., English, Chinese, Spanish, and/or the like), and/or other text string, that may serve as a starting point for a language model and/or other language processing. A prompt may include only a user input or may be generated based on a user input, such as by a prompt generation module (e.g., of a document search system) that supplements a user input with instructions, examples, and/or information that may improve the effectiveness (e.g., accuracy and/or relevance) of an output from the language model. A prompt may be provided to an LLM which the LLM can use to generate a response (or “model output”).

A User Operation (or “User Input”) can be any operations performed by one or more users to user interface(s) and/or other user input devices associated with a system (e.g., the data extraction system). User operation can include a request for task(s) to be performed, such as by using a machine learning model and/or an LLM, in whole or in part. User operation can include a request for data, such as data accessed and/or processed by one or more services. User operation can include one or more queries, one or more questions, one or more requests, or the like. User operation may include one or more natural language instructions for some data analysis (e.g., prediction, estimation, classification, or the like) to be performed. User operations can include, for example, select, drag, move, group, or the like, one or more interactive graphical representations for updating an ontology.

A Software Application (or “Application”) can be any computer-executable program or group of programs, scripts, routines, and/or the like, designed to perform specific tasks for users. The tasks performed can range from productivity functions, such as document processing, email management, and spreadsheet management, to entertainment, such as gaming and media playback, or other types of tasks. A software application may be built to run on various platforms, including desktop computers, mobile devices, servers, web browsers and/or the like, and they can interact with the underlying operating system to utilize hardware resources and provide a user interface for interaction. A software application may be developed using programming languages and frameworks that are suited to the target platform. A software application can be used to perform various actions (e.g., send or unsend an email, edit or update a document, or the like) on various data objects of data object types (e.g., a document data object, a log data object, an email data object, or the like).

An Ontology can include stored information that provides a data model for storage of data in one or more databases and/or other data stores. For example, the stored data may include definitions for data object types and respective associated property types. An ontology may also include respective link types/definitions associated with data object types, which may include indications of how data object types may be related to one another. An ontology may also include respective actions associated with data object types or data object instances. The actions may include defined changes to values of properties based on various inputs. An ontology may also include respective functions, or indications of associated functions, associated with data object types, which functions may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types. An ontology may be used by an organization to model a view of, or provide a template for, what objects exist in the world, what their properties are, and how they are related to each other.

A Data Object (or “Object” or “Data Object Instance”) is a data container for information representing a specific thing in the world that has a number of definable properties. For example, a data object can represent a machine learning model. A data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object's attributes (also referred to as “contents”) may be represented in one or more properties. Attributes may include, for example, metadata about an object, such as a geographic location associated with the item, a value associated with the item, a probability associated with the item, an event associated with the item, and so forth. A data object may be of a data object type, where the data object is stored in a database that is associated with an ontology that defines the data object type.

A Data Store is any computer-readable storage medium and/or device (or collection of data storage mediums and/or devices). Examples of data stores include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. Another example of a data store is a hosted storage environment that includes a collection of physical data storage devices that may be remotely accessible and may be rapidly provisioned as needed (commonly referred to as “cloud” storage). According to various implementations, any data storage, data stores, databases, and/or the like described in the present disclosure may, in various implementations, be replaced by appropriate alternative data storage, data stores, databases, and/or the like.

A Database is any data structure (and/or combinations of multiple data structures) for storing and/or organizing data, including, but not limited to, relational databases (e.g., Oracle databases, PostgreSQL databases, MySQL databases, and the like), non-relational databases (e.g., NoSQL databases, and the like), in-memory databases, spreadsheets, comma separated values (CSV) files, extensible markup language (XML) files, TEXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) can be understood as being stored in one or more data stores. Additionally, although the present disclosure may show or describe data as being stored in combined or separate databases, in various implementations such data may be combined and/or separated in any appropriate way into one or more databases, one or more tables of one or more databases, and/or the like. According to various implementations, any database(s) described in the present disclosure may be replaced by appropriate data store(s). Further, data source(s) of the present disclosure may include one or more databases, one or more tables, one or more data sources, and/or the like, for example.

### Example System and Related Computing Environment

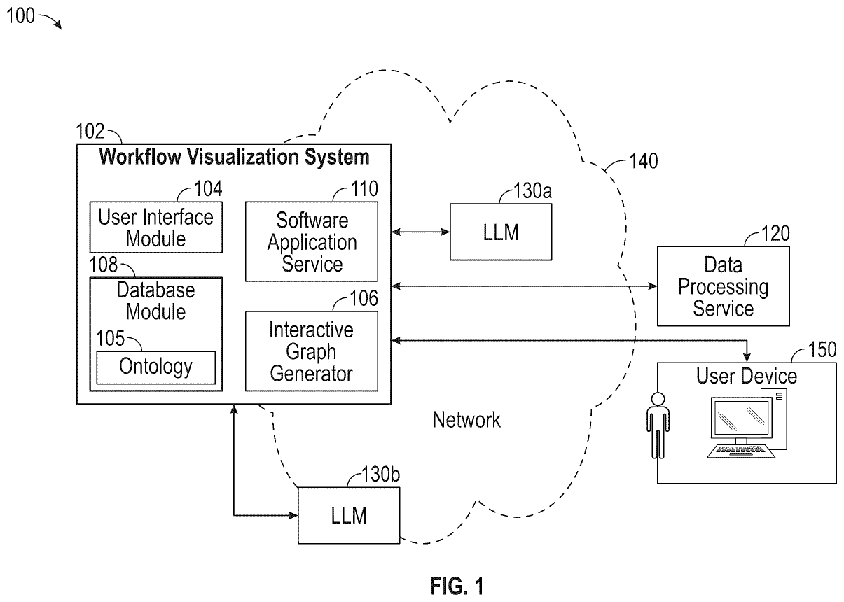

FIG. 1 illustrates an example computing environment 100 including an example workflow visualization system 102 in communication with various devices to respond to a user input or a triggering event, according to various implementations of the present disclosure. The example computing environment 100 includes the workflow visualization system 102, one or more LLMs (e.g., LLM 130a, and LLM 130b), a network 140, a data processing service 120, and a user device 150 (and/or user computing device). In the example of FIG. 1, the workflow visualization system 102 comprises various modules, including a user interface module 104, an interactive graph generator 106, a software application service 110, and a database module 108 that includes an ontology 105. In other embodiments, the workflow visualization system 102 may include fewer or additional components.

In the example of FIG. 1, the various devices are in communication via a network 140, which may include any combination of networks, such as one or more local area network (LAN), personal area network (PAN), wide area network (WAN), Global System for Mobile Communications (GSM) network, a Code Division Multiple Access (CDMA) network, a Long Term Evolution (LTE) network, the Internet, and/or any other communication network. The network 140 can use protocols and components for communicating via the Internet or any of the other aforementioned types of networks. For example, the protocols used by the network 140 may include Hypertext Transfer Protocol (HTTP), HTTP Secure (HTTPS), Message Queue Telemetry Transport (MQTT), Constrained Application Protocol (CoAP), and the like. In various implementations, modules of the illustrated components, such as the user interface module 104, the interactive graph generator 106, the database module 108, and the software application service 110 of the workflow visualization system 102, may communicate via an internal bus and/or via the network 140. Additionally, the workflow visualization system 102 may communicate with the one or more LLMs (e.g., the LLM 130a and the LLM 130b) and the data processing service 120 via the network 140 in the course of fulfilling an objective and/or a user input.

The data processing service 120 may include any quantity of services (or “plug-ins”) and any available type of service. For example, the data processing service 120 may include one or more search services (e.g., a similarity search service, a table search service, an object search service, a text search service, or any other appropriate search service), indexing services, services for formatting text or visual graphics, services for generating, creating, embedding and/or managing interactive objects in a graphical user interface, services for caching data, services for writing to databases, an ontology traversing service (e.g., for traversing the ontology 105 or performing search-arounds in the ontology 105 to surface linked objects or other data items) or any other services. In some implementations, the data processing service 120 may be a part of the workflow visualization system 102 (e.g., as part of a data processing service module of the workflow visualization system 102), in whole or in part.

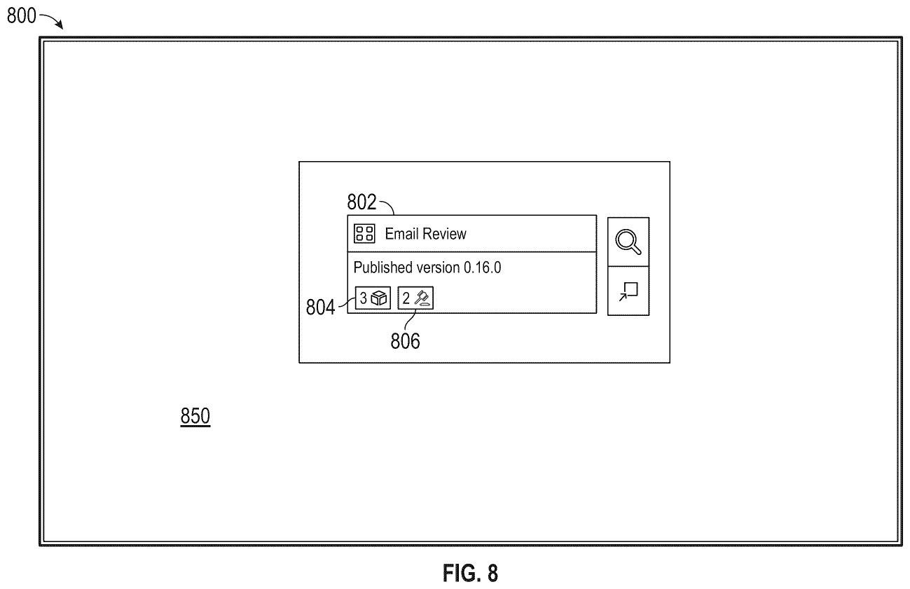

The user interface module 104 is configured to generate user interface data that may be rendered on a user device 150, such as to receive an initial user input, as well as later user input that may be used to initiate further data processing. In various implementations, the functionality discussed with reference to the user interface module 104, and/or any other user interface functionality discussed herein, may be performed by a device or service outside of the workflow visualization system 102 and/or the user interface module 104 may be outside the workflow visualization system 102. Example user interfaces are described in greater detail below with reference to FIGS. 8, 9, 10, 11, 12 and 13.

The database module 108 is configured to store data that may be accessed by the user device 150 and/or various aspects of the workflow visualization system 102, as described herein. For example, the database module 108 is configured to store data/information that may be utilized by the interactive graph generator 106, the software application service 110, and/or accessed or manipulated by the user device 150. The database module 108 of the workflow visualization system 102 may obtain and store data and/or information from the data processing service 120. Data that may be stored by the database module 108 may include any type of electronic data, such as error logs, code files, documents, text, data files, books, manuals, emails, images, audio, video, databases, metadata, positional data (e.g., geo-coordinates), sensor data, web pages, time series data, and/or any combination of the foregoing and/or the like. The database module 108 may store the data using the ontology 105, or based on the ontology 105, which may define data types and associated properties, and relationships among data types, data object types, properties, and/or the like. The ontology 105 may constitute a way to represent things in the world. The ontology 105 may be used by an organization to model a view on what objects exist in the world, what their properties are, and how they are related to each other. The ontology 105 may be user-defined, computer-defined, or some combination of the two. The ontology 105 may include hierarchical relationships among data object types.

The software application service 110 can host, include, and/or provide one or more software applications, and information related to (e.g., configurations for configuring the one or more software applications) the one or more software applications. The software application service 110 may send and receive data to/from user device(s) 150, the interactive graph generator 106, the data processing service 120, the LLM 130a, and/or the LLM 130b. For example, the software application service 110 may connect to the data processing service 120 through an application programming interface (“API”) and retrieve or submit data to/from the data processing service 120 through appropriate API calls. Similarly, the software application service 110 may receive data from an API from user device(s) 150 through appropriate API calls. The software application service 110 can be utilized to perform various tasks for fulfilling an objective (e.g., sending an email, performing a calculation, editing a document, or the like) and/or a user request from the user device 150.

As shown in FIG. 1, the workflow visualization system 102 may be capable of interfacing with multiple LLMs. This allows for experimentation, hot-swapping and/or adaptation to different models based on specific use cases or requirements, providing versatility and scalability to the system. In various implementations, the workflow visualization system 102 may interface with the LLM 130b and/or the LLM 130a in order to, for example, generate a natural language summary of a function code used to implement actions within the software application. Although FIG. 1 illustrates that the LLM 130a and the LLM 130b are external to the workflow visualization system 102, in various implementations the LLM 130a and/or the LLM 130b can be internal to the workflow visualization system 102.

In some implementations, the workflow visualization system 102 may utilize interactive visualization, data analysis, data processing, and/or machine learning techniques to provide interactive analysis of one or more software applications. For example, the workflow visualization system 102 may utilize the interactive graph generator 106 to generate graphical representations including nodes and edges to represent data objects, actions, and/or software applications of the software application service 110. The workflow visualization system 102 may further present the graphical representations to the user device 150 through the user interface module 104 to facilitate efficient management on data objects, actions, functions, logics, and/or the like associated with software applications of the software application service 110.

More specifically, the workflow visualization system 102 (e.g., the interactive graph generator 106) may access a configuration of a software application provided by the software application service 110. The configuration of the software application may include information used for configuring the software application. Based on the configuration of the software application, the workflow visualization system 102 (e.g., the interactive graph generator 106) may determine that one or more actions and one or more data object types are associated with the software application. In some implementations, the workflow visualization system 102 may utilize the data processing service 120 (e.g., a similarity search service, a data analysis service, or the like) and the ontology 105 of the database module 108 to determine that one or more actions and one or more data object types are associated with the software application. Based at least on the one or more actions and the one or more data object types associated with the software application, the workflow visualization system 102 (e.g., the interactive graph generator 106) may generate an interactive graphical representation comprising a first node representing the software application, a first user interface element of the first node, and a second user interface element of the first node. The first user interface element of the first node may indicate that the one or more data object types are associated with the software application. The second user interface element of the first node may indicate that the one or more actions are associated with the software application. The workflow visualization system 102 may provide the interactive graphical representation to the user device 150 through a user interface that is provided by the user interface module 104.

### Example System and Related Modules

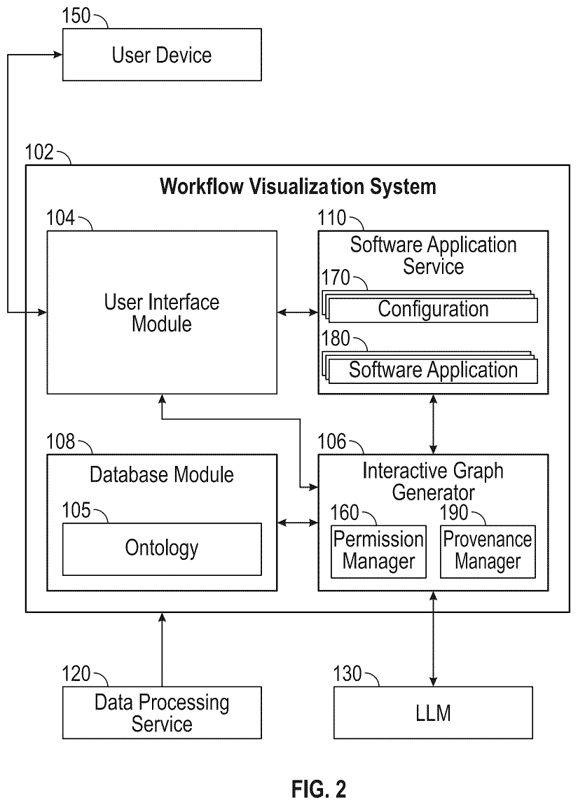

FIG. 2 depicts example connections and/or communications between various modules of the workflow visualization system 102, including the user interface module 104, the interactive graph generator 106, the database module 108, and the software application service 110. In other embodiments, the workflow visualization system 102 may include fewer or additional connections/communications. The indicated connections and/or data flows of FIG. 2 are exemplary of only certain processes performed by the workflow visualization system 102 and is not meant to include all possible blocks and participants.

As shown in FIG. 2, the interactive graph generator 106 includes at least a permission manager 160 and a provenance manager 190. The permission manager 160 can be utilized to generate interactive graphical representations (e.g., interactive node graphs) based on permissions associated with the user device 150 and/or the ontology 105. The provenance manager 190 can be utilized to generate interactive graphical representations based on relationships (e.g., dependencies, lineage, or provenance) among the information used for configuring a software application. The software application service 110 can include at least one or more configurations 170 and one or more software applications 180. Each of the one or more configurations 170 may be associated with each of the one or more software applications 180. As noted above, a configuration 170 may include information used for configuration a software application 180.

The interactive graph generator 106 may generate interactive node graph or graphical representations comprising nodes and edges related to a software application 180. For example, the interactive graph generator 106 can access one or more data stores (e.g., the database module 108 or other data store not shown in FIG. 2) associated with the software application service 110 that store a configuration 170 of the software application 180. The configuration 170 of the software application 180 may include information used for configuring the software application 180, such as widgets (e.g., a button, a tab with which users can interact), code (e.g., Python code), variables, and/or functions used to configure the software application 180. In some implementations, the configuration 170 of the software application 180 can be stored by the software application service 110 using a JavaScript Object Notation (“JSON”) format to define or describe the information (e.g., widgets, code, variables, and/or functions) and relationships (e.g., dependencies, lineage, or provenance) among the information used for configuring the software application 180. The interactive graph generator 106 may access and parse the configuration 170 to determine or identify actions (e.g., send an email, unsend an email, edit a document, or the like), data object types (e.g., an email data object type, a document data object type, or the like) that are associated with the software application 180.

For example, the provenance manager 190 may access the configuration 170 to extract the widgets, the code, the variables, and/or the functions along with relationships of the information for configuring the software application 180. Based on the extraction and/or the relationships, the provenance manager 190 may parse or traverse at least the widgets, the code, the variables, and/or the functions to determine that one or more actions and one or more data object types are referenced or used by the widgets, the code, the variables, and/or the functions. The provenance manager 190 may further determine that the one or more actions and the one or more data object types are associated with the software application 180. By parsing and/or traversing the information included in the configuration 170, the provenance manager 190 may also determine lineage or provenance among the one or more actions, the one or more data object types, and the software application 180.

In some implementations, the provenance manager 190 may utilize the data processing service 120 (e.g., a similarity search service) and/or the ontology 105 to parse the widgets, the code, the variables, or the functions to identify the one or more actions, the one or more data object types, and the lineage among the one or more actions, the one or more data object types, and the software application 180. For example, the code of the software application 180 may refer to an identification number of a data object type without further identifying the data object type. By utilizing the ontology 105 to parse the code, the provenance manager 190 may identify additional information (e.g., properties of the data object type, links between the data object type and other data object types) about the data object type, and include the additional information in an interactive node graph to be generated by the interactive graph generator 106 and/or provided through the user interface module 104. Advantageously, the ontology 105 may be helpful for the provenance manager 190 to identify relationships, properties, and/or links between data object types and understand the overall structure of and data dependency associated with the software application 180.

The permission manager 160 may allow granular permissions for providing fine-grained control over user access and actions within the software application 180 to ensure that users have appropriate levels of access and/or execution based on user permissions (e.g., dependent upon their roles, responsibilities in an organization, and/or the context of their interactions with the software application 180), and/or other criteria. As such, a user (e.g., the user device 150) may be able to view more, access more, and/or perform more operations associated with an interactive graphical representation compared with another user, depending on user permissions. Additionally and/or optionally, the permission manager 160 may allow the scope of information associated with the software application 180 included in an interactive graphical representation to be dependent upon the ontology 105 associated with the software application 180. For example, when the software application 180 is associated with a first ontology, the permission manager 160 may allow more information associated with the software application 180 to be provided through the interactive graphical representation compared with situations where the software application 180 is associated with a second ontology.

The permission manager 160 may define permissions at different levels of granularity, ranging from broad access to specific, fine-grained control. For example, the user device 150 may have permission to access a data object type but may be restricted from performing certain actions on the data object type. Advantageously, this scope of permissions ensures that users have access only to the data object types and actions based on their permissions. In some implementations, based on permissions defined by the permission manager 160, the interactive graphical representation presented through the user interface module 104 may include a coloration scheme that visually distinguishes nodes and edges based on user permissions. For example, nodes representing data object types or actions that the user device 150 can access or perform may be colored differently from those that the user device 150 cannot access or perform. This visual differentiation helps users to quickly understand their access levels and navigate the application accordingly. In some implementations, the permission manager 160 may utilize coloration scheme or other visual distinguishment techniques to differentiate between permissions to execute actions, and permissions to edit data objects. For example, the interactive graphical representation generated based on permissions defined by the permission manager 160 may indicate (e.g., through a coloration scheme) that the user device 150 may be permitted to execute an action (e.g., send an email) but may not have permission to edit a data object (e.g., the email content) to ensure that the user device 150 can perform necessary actions without compromising the integrity of the data.

Based at least on the one or more actions and one or more data object types identified from parsing or traversing (e.g., by the provenance manager 190) the configuration and/or permissions defined by the permission manager 160, the interactive graph generator 106 may generate an interactive graphical representation (e.g., interactive node graphs that will be described with reference to FIGS. 8 through 13) that can be provided to the user device 150 through the user interface module 104. The interactive graphical representation may include nodes and edges, where nodes represent the one or more actions, the one or more data object types, and/or the software application 180. Edges may represent the relationships and dependencies between the nodes to indicate lineage or provenance among the one or more actions, the one or more data object types, and the software application 180 determined by the provenance manager 190 based on the configuration 170. For example, an edge may be directed from a node representing a data object type (e.g., a team member data object type) to another node representing the software application 180 (e.g., an email review application program) to indicate that the software application 180 reads a data object of the data object type. As another example, an edge may be directed from a node representing an action (e.g., send email) to another node representing a data object type (e.g., an email data object type) to indicate that the action edits a data object of the data object type.

In some implementations, node(s) in the interactive graphical representation may include user interface elements (e.g., icon, button, or the like) that indicate and/or provide additional information about a data object type, an action, or the software application 180 represented by the node(s). For example, a node representing the software application 180 may include a first user interface element indicating that the one or more data object types are associated with the software application 180. The node may further include a second user interface element indicating that the one or more actions are associated with the software application 180. Advantageously, these user interface elements may allow users to quickly identify actions and data object types that are associated with a software application 180.

The user interface module 104 may allow the user device 150 to interact with the interactive graphical representation by making selections on nodes, edges, and/or user interface elements associated with the nodes. For example, selecting a user interface element of a node (e.g., the user interface element represents one or more actions associated with the software application 180 that is represented by the node) may trigger the display of additional nodes and/or edges, which may represent further details or information (e.g., other software applications 180 associated with the one or more actions, data object types associated with the one or more actions) about the one or more actions. Such interaction between the interactive graphical representation may enable the user device 150 to explore and understand the relationships and dependencies within the software application 180 in an efficient, dynamic and intuitive manner. Additionally, displaying additional details through the interactive graphical representation in response to user interactions (e.g., selecting specific nodes) is conducive to allow the workflow visualization system 102 to provide compact and efficient visualization, thereby improving the layout and display of nodes and edges to ensure that the interactive graphical representation is easy for users to navigate and understand.

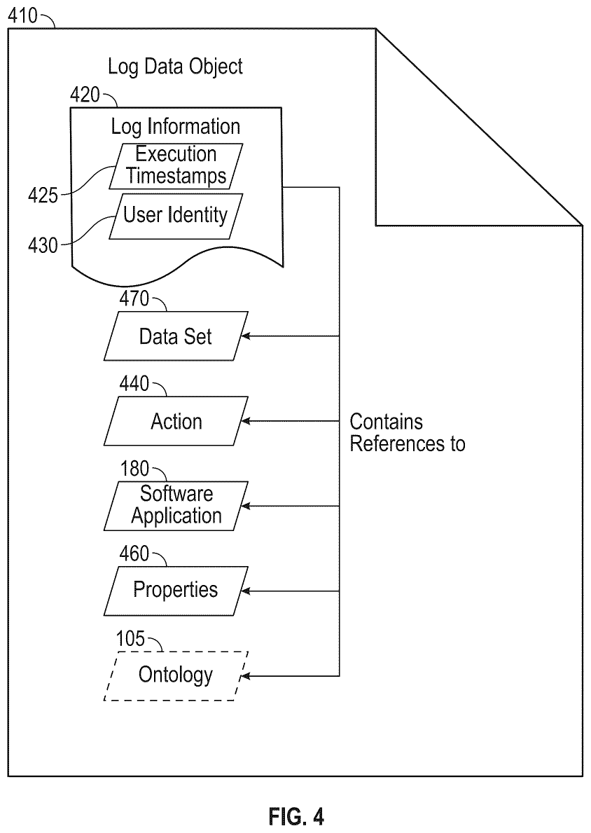

Additionally and/or optionally, the interactive graphical representation generated by the interactive graph generator 106 may further include one or more nodes that represent log data objects (e.g., a log data object 410 that will be described with reference to FIG. 4) of a log data object type associated with the software application 180. For example, a node representing an action log that records at least a timestamp and user identity associated with performance of an action may be displayed through the interactive graphical representation in response to a user operation (e.g., select, click, or the like) on another node representing the action. In some implementations, responsive to a selection on the node representing the action log, the timestamp and user identity associated with performance of the action may be display through a bottom pane or a left pane of a user interface that includes the interactive graphical representation. Advantageously, the action log may allow users to view and analyze the history of actions and/or their impact on the software application 180, which may be particularly useful for debugging and maintaining the software application 180.

In some implementations, the interactive graph generator 106 may provide a split-screen mode to the user device 150 through the user interface module 104. In the split-screen mode, the interactive graphical representation may be displayed adjacent to the software application 180 itself (e.g., a user interface of the software application 180 that allows users to operate the software application 180). This split-screen mode may enhance a user's ability to understand and manage the relationships and dependencies within the software application 180. The split-screen mode may juxtapose the interactive graphical representation with the software application 180 to allow users to simultaneously view and/or manage the interactive graphical representation of the actions and data object types associated with the software application 180 and the actual software application interface. Advantageously, the split-screen mode provides a comprehensive view, enabling users to correlate the visual representation with the functional aspects of the software application 180.

The split-screen mode may be entered in response to a user operation on a node of the interactive graphical representation that represents the software application 180, or in response to a user input (e.g., entering a command through the user interface module 104, selecting an icon, a button, a tab presented through the user interface module 104, or the like) to the workflow visualization system 102, thereby displaying the interactive graphical representation and the software application 180. When a user selects a functional component (e.g., a button, a tab, an article, an icon) within the software application 180, the corresponding node in the interactive graphical representation may be highlighted. For example, when a user selects an email in the software application 180, a corresponding node in the interactive graphical representation that represents an email data object type may be highlighted. Conversely, in some implementations, selecting a node in the interactive graphical representation may highlight a corresponding functional component in the software application 180. This unidirectional and/or bidirectional highlighting helps users quickly identify and understand the connections between a software application's functional components and their corresponding graphical representations.

Advantageously, the split-screen mode may facilitate efficient navigation between the interactive graphical representation associated with the software application 180 and the software application 180 itself. Users can easily switch between exploring the interactive graphical representation and interacting with the software application 180 to seamlessly navigate and efficiently manage the software application 180. The split-screen mode may also be useful for debugging and maintaining the software application 180. By juxtaposing the interactive graphical representation and the software application 180, users may quickly identify issues and analyze dependencies to efficiently manage or update the software application 180.

In some implementations, as noted above, the workflow visualization system 102 may allow user to interact with the workflow visualization system 102 through a user interface (e.g., a graphical user interface (“GUI”) or other types of user interfaces) provided by the user interface module 104, and receive user operations on an interactive graphical representation that is presented through the user interface. The user interface module 104 may use one or more user interfaces to present the interactive graphical representation associated with the software application 180, and the software application 180 itself. The user interface may allow users to make selections on nodes, edges, and user interface elements within the interactive graphical representation. For example, selecting a node representing a data object type may trigger the display of additional nodes and edges, providing further details about the data object type through the user interface.

Besides providing the interactive graphical representation and/or the software application through one or more user interfaces provided by the user interface module 104, the workflow visualization system 102 may utilize a user interface to provide information panel(s) adjacent to the interactive graphical representation and/or the software application 180. In some implementations, the information panel(s) may include information to assist users to more efficiently manage the software application 180. For example, as noted above, a user interface may include an action log that records actions performed within the software application 180. The action log can be displayed through a bottom pane or a left pane of the user interface, allowing users to view and analyze the history of actions and their impact on the software application's components. As another example, the workflow visualization system 102 can use the LLM 130 to generate a natural language summary of a function code used to implement actions within the software application 180. The summary may be displayed in a summary panel via the user interface, providing users with a concise and understandable overview of the function code.

### Example Database and Data Models

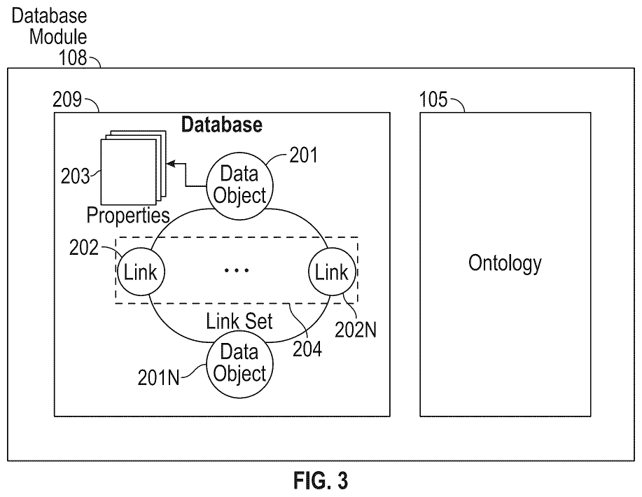

FIG. 3 illustrates an object-centric conceptual data model in the database module 108 of the workflow visualization system 102 according to various implementations of the present disclosure. The database module 108 may store the ontology 105 and the database 209. The ontology 105, as noted above, may include stored information providing a data model for storage of data in the database 209. The ontology 105 may be defined by one or more data object types, which may each be associated with one or more property types. At the highest level of abstraction, data object 201 is a container for information representing things in the world. For example, the data object 201 can represent an entity such as a particular person, place, organization, date, market instrument, item, or other noun, where the entity may appear in text data such as a document, an e-mail message, a news report, a written paper, an article, or the like. Data object 201 can also represent an event that happens at a point in time or for a duration. Each data object 201 may be associated with a unique identifier that uniquely identifies the data object within the database 209 of the database module 108.

In various implementations, different types of data objects may have different property types. For example, a “Person” data object might have an “Eye Color” property type and an “Event” data object might have a “Date” property type. Each property 203 as represented by data in the database module 108 may have a property type defined by the ontology 105 used by the database module 108. Objects may be instantiated in the database 209 in accordance with the corresponding object definition for the particular object in the ontology 105. For example, a specific monetary payment (e.g., an object of type “event”) of US$30.00 (e.g., a property of type “currency”) taking place on Mar. 27, 2009 (e.g., a property of type “date”) may be stored in the database 209 as an event object with associated currency and date properties as defined within the ontology 105. The data objects defined in the ontology 105 may support property multiplicity. In particular, the data object 201 may be allowed to have more than one property 203 of the same property type. For example, a “Person” data object might have multiple “Address” properties or multiple “Name” properties. Each link 202 represents a connection between two data objects 201. In one implementation, the connection is either through a relationship, an event, or through matching properties. A relationship connection may be asymmetrical or symmetrical. For example, “Person” data object A may be connected to “Person” data object B by a “Child Of” relationship (where “Person” data object B has an asymmetric “Parent Of” relationship to “Person” data object A), a “Kin Of” symmetric relationship to “Person” data object C, and an asymmetric “Member Of” relationship to “Organization” data object X. The type of relationship between two data objects may vary depending on the types of the data objects. For example, “Person” data object A may have an “Appears In” relationship with “Document” data object Y or have a “Participate In” relationship with “Event” data object E. As an example of an event connection, two “Person” data objects may be connected by an “Airline Flight” data object representing a particular airline flight if they traveled together on that flight, or by a “Meeting” data object representing a particular meeting if they both attended that meeting. In one implementation, when two data objects are connected by an event, they are also connected by relationships, in which each data object has a specific relationship to the event, such as, for example, an “Appears In” relationship.

As an example of a matching properties connection, two “Person” data objects representing a brother and a sister, may both have an “Address” property that indicates where they live. If the brother and the sister live in the same home, then their “Address” properties likely contain similar, if not identical property values. In one implementation, a link between two data objects may be established based on similar or matching properties (e.g., property types and/or property values) of the data objects. These are just various examples of the types of connections that may be represented by a link and other types of connections may be represented; implementations are not limited to any particular types of connections between data objects. For example, a document might contain references to two different objects. For example, a document may contain a reference to a payment (one object), and a person (a second object). A link between these two objects may represent a connection between these two entities through their co-occurrence within the same document. Each data object 201 can have multiple links with another data object 201 to form a link set 204. For example, two “Person” data objects representing a husband and a wife could be linked through a “Spouse Of” relationship, a matching “Address” property, and one or more matching “Event” properties (e.g., a wedding). Each link 202 as represented by data in the database 209 may have a link type defined by the ontology 105 and/or used by the database 209.

For case of understanding, in some implementations, data objects (e.g., the data object 201 and the data object 201N), links between data objects (e.g., the link 202 and link 202N) that may represent relationships between the data objects, and properties of data objects (e.g., the properties 203) can be visualized using one or more graphical user interfaces (GUI). For example, an example user interface may show a graphical representation of relationships between data objects that are represented as nodes in the graphical representation. The data objects may include, for example, person data objects, flight data objects, account data objects, computer data objects, and/or the like. The objects/nodes may have relationships and/or links with any of the other objects/nodes.

In some implementations, relationships between data objects may be stored as links, or in some implementations, as properties, where a relationship may be detected between the properties. In some cases, as stated above, the links may be directional. For example, a payment link may have a direction associated with the payment, where one person object is a receiver of a payment, and another person object is the payer of payment.

In addition to visually showing relationships between the data objects, a user interface may allow various other manipulations. For example, the objects within database module 108 may be searched using a search interface (e.g., text string matching of object properties), inspected (e.g., properties and associated data viewed), filtered (e.g., narrowing the universe of objects into sets and subsets by properties or relationships), and statistically aggregated (e.g., numerically summarized based on summarization criteria), among other operations and visualizations.

FIG. 4 is a block diagram illustrating an example log data object 410, according to various implementations of the present disclosure. The log data object 410 may be stored by the interactive graph generator 106 in the database 209 of the database module 108. In various implementations, the workflow visualization system 102 (e.g., the interactive graph generator 106) may utilize the log data object 410 to store an action log that includes information related to performance of an action associated with the software application 180.

As shown in FIG. 4, the log data object 410 can be linked to data object(s) that represent an action 440 (e.g., send an email, unsend an email, edit a document, or the like) associated with the software application 180. The log data object 410 can also be linked to data object(s) that represent data set 470 (e.g., any type of electronic data, such as text, files, documents, books, manuals, time series data, emails, images, audio, video, databases, metadata, positional data (e.g., geo-coordinates), sensor data, web pages, and/or any combination of the foregoing and/or the like that may be accessed during the performance of the action 440) associated with the action 440.

Additionally and/or optionally, the log data object 410 may include or be linked to the log information 420 that includes execution timestamps 425 and user identity 430. The execution timestamps 425 may indicate when the action 440 was performed. The user identity 430 may indicate which user(s) (e.g., user identities) performed the action 440. The log data object 410 may also be linked to the software application 180 with which the action 440 is associated, and the ontology 105 that may be associated with the software application 180. The log data object 410 may also be associated with properties 460 that may be defined by the ontology 105. The properties 460 may include attributes and/or metadata about the log data object 410. The properties 460 can provide additional information or context about the action 440. For example, the properties 460 can include data dependencies or relationships between the action 440 and other actions or other data objects.

Advantageously, by referencing and/or linking to the data set 470, the action 440, the software application 180, the properties 460, and/or the ontology 105, the log data object 410 can capture detailed information about the action 440 performed using the software application 180. For example, if the action 440 involves editing a document, the data set 470 may include an identifier of the document, thereby facilitating debugging, auditing, and/or maintaining the software application 180.

### Example Functionality and Operations of the System

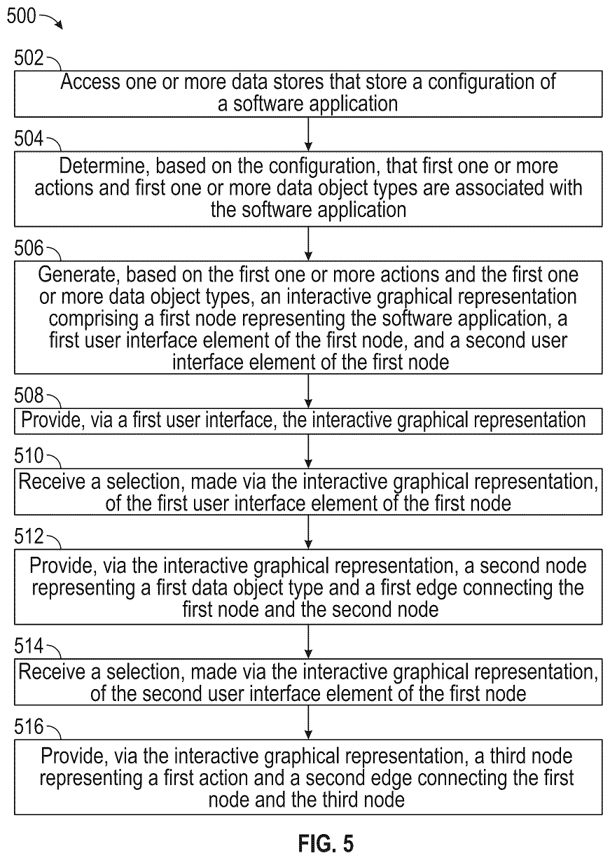

FIGS. 5, 6A, 6B, and 7 show flowcharts illustrating example operations of the workflow visualization system 102 (and/or various other aspects of the example computing environment 100), according to various embodiments. The blocks of the flowcharts illustrate example implementations, and in various other implementations various blocks may be rearranged, optional, and/or omitted, and/or additional block may be added. In various embodiments, the example operations of the system illustrated in FIGS. 5, 6A, 6B, and 7 may be implemented, for example, by the one or more aspects of the workflow visualization system 102, various other aspects of the example computing environment 100, and/or the like.

FIG. 5 depicts a flowchart illustrating an example method 500 according to various embodiments. The method 500 may be implemented, for example, by the workflow visualization system 102 of FIGS. 1 and 2 to generate interactive graphical representations to represent data object types and actions associated with the software application 180. In various implementations, the method 500 may be performed in part or in full by the workflow visualization system 102. For example, the workflow visualization system 102 may perform blocks 502, 504, 506, and 508 without performing blocks 510, 512, 514, or 516.

At block 502, the workflow visualization system 102 may access one or more data stores that store a configuration of a software application. For example, as noted above, the interactive graph generator 106 can access one or more data stores (e.g., the database module 108 of FIGS. 1 and 2) associated with the software application service 110 that store a configuration 170 of the software application 180. The configuration 170 of the software application 180 may include information used for configuring the software application 180, such as widgets (e.g., a button, a tab with which users can interact), code (e.g., Python code), variables, and/or functions used to configure the software application 180. In some implementations, the configuration 170 of the software application 180 can be stored by the software application service 110 using a JavaScript Object Notation (“JSON”) format to define or describe the information (e.g., widgets, code, variables, and/or functions) and relationships (e.g., dependencies, lineage, or provenance) among the information used for configuring the software application 180.

At block 504, the workflow visualization system 102 may determine, based on the configuration 170, that first one or more actions and first one or more data object types are associated with the software application 180. For example, the provenance manager 190 may access the configuration 170 to extract the widgets, the code, the variables, and/or the functions along with relationships of the information for configuring the software application 180. Based on the extraction and/or the relationships, the provenance manager 190 may parse or traverse at least the widgets, the code, the variables, and/or the functions to determine that the first one or more actions and the first one or more data object types are referenced or used by the widgets, the code, the variables, and/or the functions. The provenance manager 190 may further determine that the first one or more actions and the first one or more data object types are associated with the software application 180. By parsing and/or traversing the information included in the configuration 170, the provenance manager 190 may also determine lineage or provenance among the first one or more actions, the first one or more data object types, and the software application 180.

In some implementations, the provenance manager 190 may utilize the data processing service 120 (e.g., a similarity search service) and/or the ontology 105 to parse the widgets, the code, the variables, or the functions to identify the first one or more actions, the first one or more data object types, and the lineage among the first one or more actions, the first one or more data object types, and the software application 180. For example, the code of the software application 180 may refer to an identification number of a data object type without further identifying the data object type. By utilizing the ontology 105 to parse the code, the provenance manager 190 may identify additional information (e.g., properties of the data object type, links between the data object type and other data object types) about the data object type, and include the additional information in an interactive node graph to be generated and/or provided through the user interface module 104. Advantageously, the ontology 105 may be helpful for the provenance manager 190 to identify relationships, properties, and/or links between data object types and understand the overall structure of and data dependency associated with the software application 180.

At block 506, the interactive graph generator 106 may generate, based on the first one or more actions and the first one or more data object types, an interactive graphical representation comprising a first node representing the software application 180, a first user interface element (e.g., a button, an icon, or the like) of the first node, and a second user interface element (e.g., a button, an icon, or the like) of the first node. The first user interface element of the first node may indicate that the first one or more data object types are associated with the software application 180. The second user interface element of the first node may indicate that the first one or more actions are associated with the software application 180. Examples of the first node, the first user interface element, and the second user interface element will be illustrated below with reference to FIG. 8.

In some implementations, as noted above, the interactive graphical representation may include nodes and edges, where nodes represent the first one or more actions, the first one or more data object types, and/or the software application 180. Edges may represent the relationships and dependencies between the nodes to indicate lineage or provenance among the first one or more actions, the first one or more data object types, and the software application 180 determined based on the configuration 170. For example, an edge may be directed from a node representing a data object type (e.g., a team member data object type) to another node representing the software application 180 (e.g., email review) to indicate that the software application 180 reads a data object of the data object type. As another example, an edge may be directed from a node representing an action (e.g., send email) to another node representing a data object type (e.g., an email data object type) to indicate that the action edits a data object of the data object type.

At block 508, the workflow visualization system 102 may provide the interactive graphical representation via a first user interface. For example, the interactive graphical representation generated by the interactive graph generator 106 may be presented to the user device 150 through the first user interface provided by the user interface module 104.

At block 510, the workflow visualization system 102 may receive a selection, made via the interactive graphical representation, of the first user interface element of the first node. More specifically, the user interface module 104 may receive the selection (e.g., a user click on a button), made via the interactive graphical representation, of the first user interface element of the first node.

At block 512, the workflow visualization system 102 may provide, via the interactive graphical representation, a second node representing a first data object type and a first edge connecting the first node and the second node. For example, in response to receiving the selection of the first user interface element of the first node, the interactive graph generator 106 may update the interactive graphical representation to include the second node and the first edge connecting the first node and the second node. The second node may represent a first data object type of the first one or more data object types associated with the software application 180. The first edge may represent that the software application 180 reads a first data object of the first data object type. The first edge may be directed from the second node to the first node to indicate that the software application 180 reads the first data object of the first data object type.

At block 514, the workflow visualization system 102 may receive a selection, made via the interactive graphical representation, of the second user interface element of the first node. More specifically, the user interface module 104 may receive the selection (e.g., a user click on a button), made via the interactive graphical representation, of the second user interface element of the first node.

At block 516, the workflow visualization system 102 may provide, via the interactive graphical representation, a third node representing a first action, and a second edge connecting the first node and the third node. For example, in response to receiving the selection of the second user interface element of the first node, the interactive graph generator 106 may further update the interactive graphical representation to include the third node and the second edge. The third node may represent a first action of the first one or more actions that are associated with the software application. The second edge may represent that the software application 180 performs the first action. The second edge may be directed from the first node to the third node to indicate that the software application 180 performs the first action.

Additionally and/or optionally, the interactive graph generator 106 may further update the interactive graphical representation to include a third edge connecting the third node and the second node. The third edge may represent that the first action edits at least the first data object of the first data object type. The third edge may be directed from the third node to the second node to indicate that the first action edits at least the first data object of the first data object type.

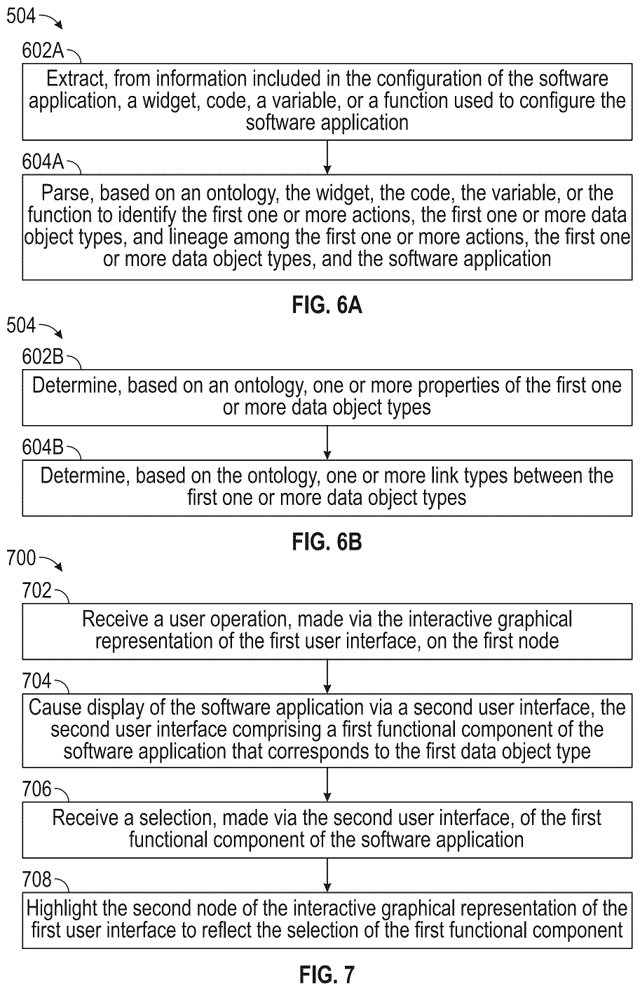

FIG. 6A is a flowchart illustrating an example implementation of the block 504 for determining that the first one or more actions and the first one or more data object types are associated with the software application 180, according to various embodiments of the present disclosure. In various implementations, the example implementation includes blocks 602A and 604A that may be performed in part or in full by the workflow visualization system 102. In various implementations, the blocks 602A and the blocks 604A may be performed by the interactive graph generator 106 concurrently and/or sequentially.

At block 602A, the workflow visualization system 102 may extract at least a widget, code, a variable, or a function used to configure the software application 180. For example, the interactive graph generator 106 may extract, from the information included in the configuration 170 of the software application 180, at least a widget, code, a variable, or a function used to configure the software application 180. As noted above, the widget may be a button, a tab, or the like with which the user device 150 can interact with the software application 180. The code can be Python code that used to configure the software application 180.

At block 604A, the workflow visualization system 102 may parse the widget, the code, the variable, or the function to identify the first one or more actions, the first one or more data object types, and lineage among the first one or more actions, the first one or more data object types, and the software application 180. For example, the interactive graph generator 106 (e.g., the provenance manager 190) may parse, based on the ontology 105, the widget, the code, the variable, or the function to identify the first one or more actions, the first one or more data object types, and lineage among the first one or more actions, the first one or more data object types, and the software application 180.

FIG. 6B is a flowchart illustrating another example implementation of the block 504 for determining that the first one or more actions and the first one or more data object types are associated with the software application 180, according to various embodiments of the present disclosure. In various implementations, the example implementation includes blocks 602B and 604B that may be performed in part or in full by the workflow visualization system 102. In various implementations, the blocks 602B and the blocks 604B may be performed by the interactive graph generator 106 concurrently and/or sequentially.

At block 602B, the workflow visualization system 102 may determine, based on an ontology, one or more properties of the first one or more data object types. For example, the provenance manager 190 may determine, based on the ontology 105, one or more properties of the first one or more data object types.

At block 604B, the workflow visualization system 102 may determine, based on an ontology, one or more link types between the first one or more data object types. For example, the provenance manager 190 may determine, based on the ontology 105, one or more link types between the first one or more data object types. Advantageously, using the ontology 105, the interactive graph generator 106 may identify additional information (e.g., properties of the data object type, links between the data object type and other data object types) about the data object type, and include the additional information in the interactive graphical representation that is generated to allow users to identify relationships, properties, and/or links between data object types and understand the overall structure of the software application.

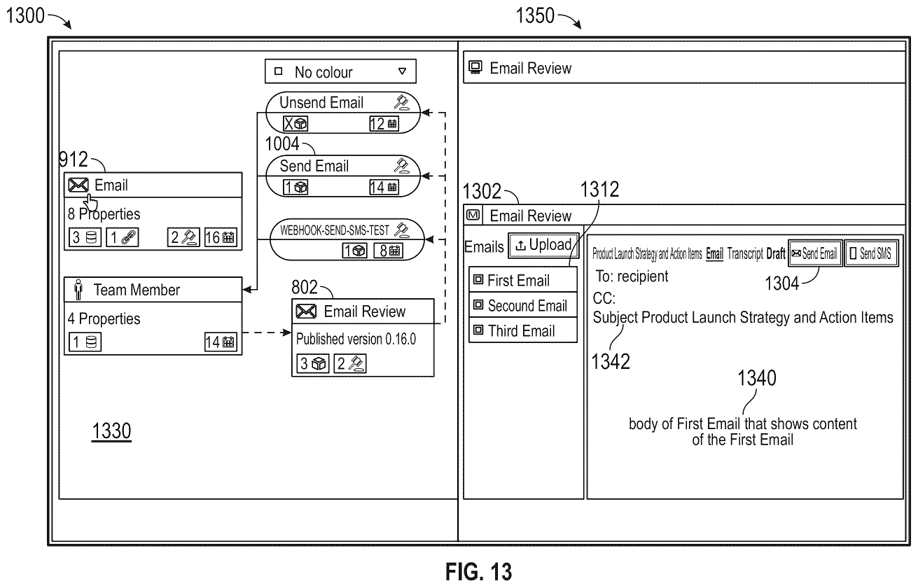

FIG. 7 is a flowchart illustrating an example method 700 for providing a split view including a graphical representation associated with the software application 180 and the software application 180 itself, according to various implementations of the present disclosure. The method 500 may be implemented, for example, by the workflow visualization system 102 (e.g., the interactive graph generator 106) of FIGS. 1 and 2. In some implementations, the method 700 may be performed after block 508, block 512, or block 516. The method 700 may be performed by the workflow visualization system 102 to generate user interfaces that will be described with reference to FIG. 13.

At block 702, the workflow visualization system 102 may receive a user operation, made via the interactive graphical representation of the first user interface, on the first node. The user operation may be any types of operations performed on the first node, such as a user click or a user selection of the first node. Such a user operation on the first node may trigger the workflow visualization system 102 to provide the split-screen mode discussed above. Alternatively, the workflow visualization system 102 (e.g., the user interface module 104) may receive other types of user input to trigger the split-screen mode. For example, the user interface module 104 may receive a user instruction or a command (e.g., through a keyboard associated with the user device 150) to trigger the split-screen mode.

At block 704, the workflow visualization system 102 may cause display of the software application 180 via a second user interface. For example, responsive to the user operation on the first node, the interactive graph generator 106 and/or the user interface module 104 may cause display of the software application 180 via a second user interface. The second user interface may include a first functional component (e.g., a button, a tab, an article, an icon) of the software application 180 that corresponds to the first data object type that is represented by the second node. For example, the first data object type represented by the second node may be an email data object type, and the first functional component may represent an email. The second user interface may be in juxtaposition with the first user interface to form a split view of the first user interface and the second user interface. As noted above, the second user interface may display the software application 180 itself, and the first user interface may display the interactive graphical representation associated with the software application 180. By juxtaposing the software application 180 and the interactive graphical representation associated with the software application 180, the workflow visualization system 102 may allow users to simultaneously view and/or manage the interactive graphical representation of the actions and data object types associated with the software application and the actual software application interface.

At block 706, the workflow visualization system 102 may receive a selection, made via the second user interface, of the first functional component of the software application 180. For example, the user interface module 104 may receive the selection of the first functional component (e.g., a specific email within the software application 180) of the software application 180.

At block 708, the workflow visualization system 102 may highlight the second node of the interactive graphical representation of the first user interface to reflect the selection of the first functional component. For example, responsive to the selection of the first functional component of the software application 180, the user interface module 104 may highlight the second node of the interactive graphical representation of the first user interface to reflect the selection of the first functional component. As such, for example, when the user device 150 selects an email (e.g., represented by the first functional component) in the software application 180, a corresponding node (e.g., the second node) in the interactive graphical representation that represents an email data object type may be highlighted to advantageously allow users to quickly identify and understand the connections between the software application's functional components and their corresponding graphical representations.

### Example User Interfaces and Related Functionality

FIGS. 8-13 show example user interfaces that illustrate example interactive graphical representations associated with a software application (e.g., the software application 180) to allow the user device 150 to more efficiently manage the software application by interacting with the interactive graphical representations. The example user interfaces may be presented through the user interface module 104 of the workflow visualization system 102 of FIGS. 1-2 and/or a user interface of the user device 150.

As shown in FIG. 8, an example user interface 800 may include an interactive graphical representation 850 that includes a node 802. The node 802 may further include a user interface element 804 and a user interface element 806. As noted above, the interactive graphical representation 850 may be generated by the workflow visualization system 102 based on the method 500. For example, the interactive graph generator 106 may perform blocks 502, 504, and 506 of the method 500 to generate the interactive graphical representation 850.

The node 802 may represent a software application (e.g., the software application 180) provided by the workflow visualization system 102. The user interface element 804 may indicate that one or more data object types are associated with the software application. The user interface element 806 may indicate that one or more actions are associated with the software application. Here, the node 802 represents the “Email Review” software application. The user interface element 804 indicates that three data object types are associated with the “Email Review” software application. The user interface element 806 indicates that two actions are associated with the “Email Review” software application.

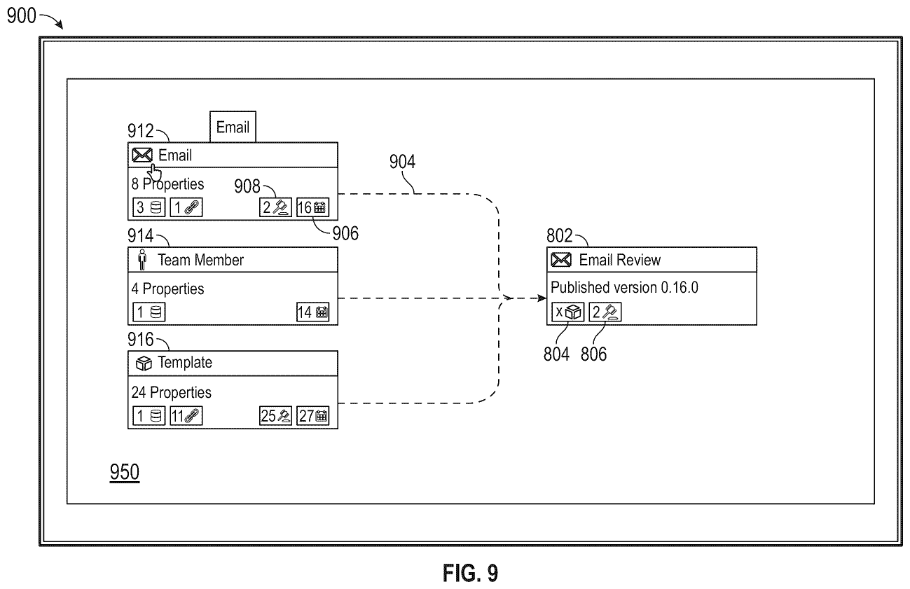

FIG. 9 shows an example user interface 900 that includes an interactive graphical representation 950. The interactive graphical representation 950 may be generated by the workflow visualization system 102 in response to receiving a selection from the user device 150 on the user interface element 804 of the node 802. For example, the interactive graph generator 106 may update the interactive graphical representation 850 to generate or provide the interactive graphical representation 950 in response to receiving the selection, made via the interactive graphical representation 850 of the user interface 800, of the user interface element 804 of the node 802.

As shown in FIG. 9, the interactive graphical representation 950 may include a node 912, a node 914, and a node 916. Each of the node 912, the node 914, and the node 916 may represent a data object type associated with the software application (e.g., the “Email Review” software application) represented by the node 802. Here, the node 912 represents the “Email” data object type, the node 914 represents the “Team Member” data object type, and the node 916 represents the “Template” data object type.

The interactive graphical representation 950 may further include at least an edge 904 connecting the node 912 and the node 802. Here, the edge 904 may represent that the software application represented by the node 802 reads a data object of the “Email” data object type represented by the node 912. The edge 904 is shown to be directed from the node 912 to the node 802 to indicate that the software application represented by the node 802 reads the data object of the “Email” data object type.

As shown in FIG. 9, the node 912 representing the “Email” data object type includes at least a user interface element 906 and a user interface element 908. The user interface element 906 may indicate that the “Email” data object type represented by the node 912 is associated with one or more software applications. Here, the user interface element 906 indicates that the “Email” data object type represented by the node 912 is associated with sixteen software applications. Although not illustrated in FIG. 9, in response to receiving a selection of the user interface element 906, the workflow visualization system 102 may update the interactive graphical representation 950 to further include sixteen nodes (not shown in FIG. 9) representing the sixteen software applications that are associated with the “Email” data object type represented by the node 912.

The user interface element 908 may indicate that the “Email” data object type represented by the node 912 is associated with one or more actions. Here, the user interface element 908 indicates that the “Email” data object type represented by the node 912 is associated with two actions. It should be noted that the two actions associated with the “Email” data object type represented by the node 912 can overlap or not overlap with the three actions (e.g., indicated by the user interface element 804) associated with the “Email Review” software application.

Although not illustrated in FIG. 9, in response to receiving a selection of the user interface element 908, the workflow visualization system 102 may update the interactive graphical representation 950 to further include two nodes (not shown in FIG. 9) representing the two actions associated with the “Email” data object type represented by the node 912. Additionally and/or optionally, in response to receiving a user operation (e.g., a click, a drag, a double-click, or the like) on the node 912, the workflow visualization system 102 may update the interactive graphical representation 950 to show links between the “Email” data object type represented by the node 912 and other data object types represented by other nodes (not shown in FIG. 9). More specifically, the interactive graph generator 106 may update the interactive graphical representation 950 to include one or more edges connecting the node 912 and the other nodes representing the other data object types. Each of the one or more edges may represent a link type between the “Email” data object type and the other data object types.

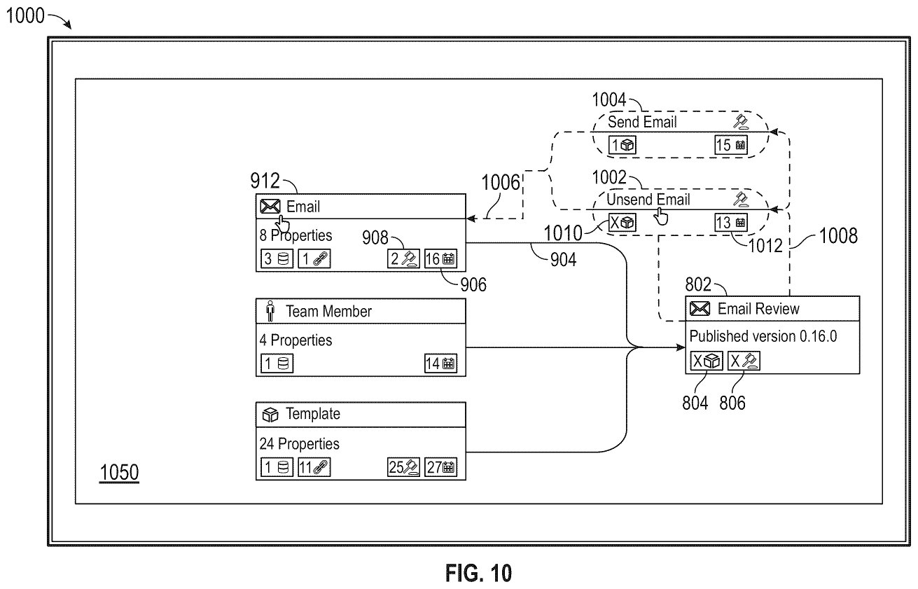

FIG. 10 shows another example user interface 1000 that includes an interactive graphical representation 1050 associated with the workflow visualization system 102, according to various implementations of the present disclosure. In various implementations, the example user interface 1000 may be presented through the user interface module 104 of the workflow visualization system 102 and/or a user interface of the user device 150 in response to a user selection from the user device 150 on the user interface element 806 of the node 802 of FIG. 8. For example, the interactive graph generator 106 may update the interactive graphical representation 950 to generate or provide the interactive graphical representation 1050 in response to receiving the selection, made via the interactive graphical representation 950 of the user interface 900, of the user interface element 806 of the node 802.

As shown in FIG. 10, the interactive graphical representation 1050 may include the node 802, the node 912, a node 1004, a node 1002, an edge 1008 connecting the node 802 and the node 1002, an edge 1006 connecting the node 1002 and the node 912. The node 1004 and the node 1002 may each represent an action associated with the software application (e.g., the “Email Review” software application) represented by the node 802. Here, the node 1004 represents the “Send Email” action, and the node 1002 represents the “Unsend Email” action. The edge 1008 represents that the software application (e.g., the “Email Review” software application) performs the “Unsend Email” action represented by the node 1002. Here, the edge 1008 directs from the node 802 to the node 1002 to indicate that the “Email Review” software application represented by the node 802 performs the “Unsend Email” action represented by the node 1002. Additionally and/or optionally, the interactive graphical representation 1050 may include the edge 1006 connecting the node 1002 and the node 912. The edge 1006 may represent that the “Unsend Email” action represented by the node 1002 edits at least a data object of the “Email” data object type represented by the node 912.

As shown in FIG. 10, the node 1002 may include a user interface element 1010 and a user interface element 1012. The user interface element 1012 of the node 1002 may indicate that the “Unsend Email” action represented by the node 1002 is associated with one or more software applications. Here, the user interface element 1012 indicates that the “Unsend Email” action is associated with thirteen software applications. The user interface element 1010 may indicate that the “Unsend Email” action represented by the node 1002 edits one or more data objects of one or more data object types.

Although not shown in FIG. 10, in response to receiving a user operation on the node 1002 via the user interface 1000, the interactive graph generator 106 may update the interactive graphical representation 1050 to show data object(s) read by the “Unsend Email” action represented by the node 1002 in addition to showing data object(s) (e.g., an email data object of the “Email” data object type represented by the node 912) edited by the “Unsend Email” action. For example, in response to receiving a user operation on the node 1002 via the user interface 1000, the interactive graph generator 106 may update the interactive graphical representation 1050 to further include one or more edges connecting the node 1002 to one or more nodes (not shown in FIG. 10). The one or more nodes may represent one or more data objects of one or more data object types read by the “Unsend Email” action represented by the node 1002. Advantageously, by displaying additional nodes and edges read by “Unsend Email” action represented by the node 1002 responsive to a user operation on the node 1002, the workflow visualization system 102 may provide compact and efficient visualization without packing too much information into visualization, thereby improving the layout and display of nodes and edges to ensure that the interactive graphical representation is easy for users to navigate and understand.

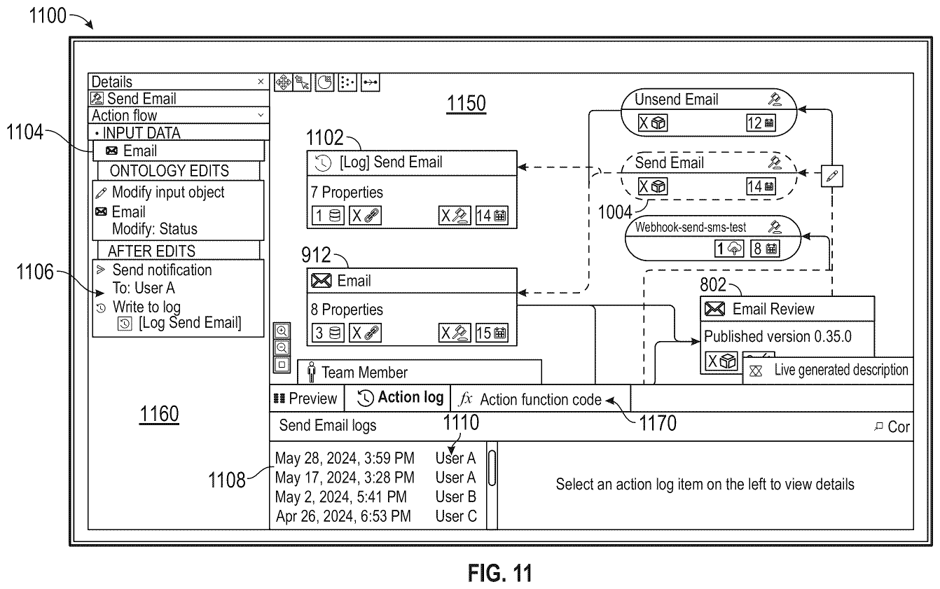

FIG. 11 shows an example user interface 1100 associated with the workflow visualization system 102, according to various implementations of the present disclosure. The user interface 1100 may include an interactive graphical representation 1150. The user interface 1100 may be presented through the user interface module 104 of the workflow visualization system 102 and/or a user interface of the user device 150. In various implementations, the interactive graph generator 106 may update the interactive graphical representation 1050 to generate or provide the interactive graphical representation 1150 in response to receiving a user operation, made via the interactive graphical representation 1050 of the user interface 1000, on the node 1004.

As shown in FIG. 11, the interactive graphical representation 1150 includes the node 802, the node 1004, the node 912, and a node 1102. The node 1102 may represent an action log that records at least a timestamp and a user associated with a performance of the “Send Email” action represented by the node 1004. Here, the node 1102 represents a “Send Email” action log. The “Send Email” action log can be stored as the log data object 410 in a database (e.g., the database module 108) associated with the workflow visualization system 102.

In some implementation, a display portion 1108 and a display portion 1110 can be displayed responsive to a user operation (e.g., a user click) on the node 1102 to present information about the “Send Email” action log represented by the node 1102. As shown by the display portion 1108 and the display portion 1110, the “Send Email” action log records at least timestamps and user identities, indicating which users performed the “Send Email” action at what times. Here, the display portion 1108 and the display portion 1110 show that “User A” performed the “Send Email” action at 3:59 PM on May 28, 2024, “User A” performed the “Send Email” action at 3:28 PM on May 17, 2024, “User B” performed the “Send Email” action at 5:41 PM on May 2, 2024, and “User C” performed the “Send Email” action at 6:53 PM on Apr. 26, 2024. Advantageously, the “Send Email” action log represented by the node 1102 may allow users to view and analyze the history of actions and/or their impact on the software application 180, which may be useful for debugging and maintaining the software application 180.

Additionally and/or optionally, in response to receiving a user operation on the node 1004 made via the interactive graphical representation 1150, the workflow visualization system 102 may provide an information panel 1160 via the user interface 1100. The information panel 1160 may include information about input data used by the “Send Email” action represented by the node 1004 and/or information about output data or results generated by the “Send Email” action. Here, the information panel 1160 includes a display portion 1104 and a display portion 1106. The display portion 1104 shows input data used by the “Send Email” action represented by the node 1004. The display portion 1104 shows that the input data used by the “Send Email” is an “Email.” The display portion 1106 shows output or results generated after performing the “Send Email” action. Here, the display portion 1106 shows that after the “Send Email” action is performed, a notification will be sent to “User A” and that the performance of the “Send Email” action will be written to the “Send Email” action log represented by the node 1102.

As shown in FIG. 11, the user interface 1100 may further include a display portion 1170. Here, the display portion 1170 reads “Action function code,” indicating that function code used to implement the “Send Email” action represented by the node 1004 can be displayed in response to a selection on the display portion 1170. Although not illustrated in FIG. 11, in some implementations, the workflow visualization system 102 may use a large language model (“LLM”) to summarize the “Action function code” used to implement the “Send Email” action represented by the node 1004 in response to receiving a user operation on the node 1004, the display portion 1170, and/or other kinds of user input to the user interface module 104. A summary of the “Action function code” can be provided via a summary panel (not shown in FIG. 11) through the user interface 1100, thereby providing users with a concise and understandable overview of the “Action function code.”

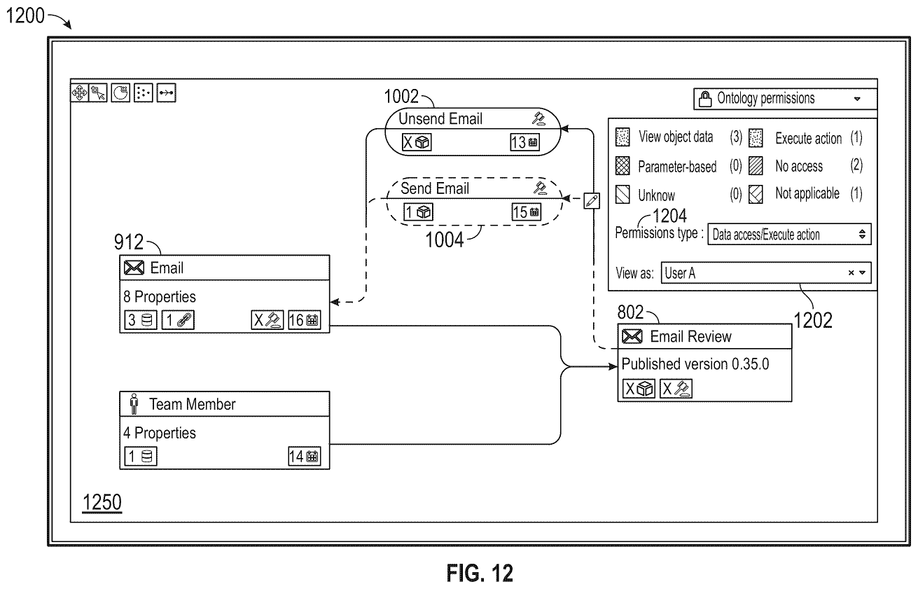

FIG. 12 shows an example user interface 1200 that includes an interactive graphical representation 1250 associated with the workflow visualization system 102, according to various implementations of the present disclosure. In various implementations, the example user interface 1200 may be presented through the user interface module 104 of the workflow visualization system 102 and/or a user interface of the user device 150. The interactive graphical representation 1250 may enable granular permissions for providing fine-grained control over user access and actions within the software application 180 to ensure that user device 150 has appropriate levels of access and/or execution based on user permissions (e.g., dependent upon their roles, responsibilities in an organization, and/or the context of their interactions with the application), and/or other criteria. The interactive graphical representation 1250 may be generated by the interactive graph generator 106 (e.g., the permission manager 160 and the provenance manager 190).

As shown in FIG. 12, the interactive graphical representation 1250 includes the node 802, the node 912, the node 1004, the node 1002, a display portion 1204, and a display portion 1202. The display portion 1204 and the display portion 1202 may allow the user device 150 to view and/or manage the interactive graphical representation 1250 based on various permissions schemes (e.g., user permissions, permission types, or the like). Here, the display portion 1204 reads “Permission type: Data access/Execute action,” indicating that the interactive graphical representation 1250 includes information about “Data access/Execute action” permissions associated with the software application 180. The display portion 1202 reads “View as: User A,” indicating that permissions information included in the interactive graphical representation 1250 is generated based on user permissions associated with “User A.”

In some implementations, the node 912, the node 1004, and the node 1002 may be displayed visually different (e.g., using a coloration scheme) to indicate whether “User A” has permission to access or execute actions and or data objects represented by the node 912, the node 1004, and the node 1002. Here, the node 1004 may be displayed in a first color (e.g., red) to show that “User A” may or may not execute the “Send Email” action represented by the node 1004. The node 912 may be displayed in a second color (e.g., brown) to indicate that “User A” may or may not access a data object of the “Email” data object type represented by the node 912. In some examples, the interactive graphical representation 1250 may indicate through the coloration scheme that “User A” is permitted to access a data object of the “Email” data object type represented by the node 912 but unpermitted to execute the “Send Email” action represented by the node 1004. The interactive graphical representation 1250 may further indicate through the coloration scheme that “User B” (not shown in FIG. 12 but can be selected through the display portion 1202) is unpermitted to access a data object of the “Email” data object type represented by the node 912 but is permitted to execute the “Send Email” action represented by the node 1004.

Advantageously, this visual differentiation helps users quickly understand their access levels and navigate the software application 180 accordingly. Further, various scope of permissions associated with various users can ensure that users have access only to the data object types and actions based on their permissions.

FIG. 13 shows example user interfaces 1300 and 1350 that are in juxtaposition with each other to form a split view, according to various implementations of the present disclosure. The user interface 1300 includes an interactive graphical representation 1330. The user interface 1350 is a user interface through which the user device 150 can operate a software application (e.g., the “Email Review” software application represented by the node 802). In some implementations, the interactive graph generator 106 may generate the interactive graphical representation 1330 by performing at least the method 500. In response to receiving a user operation made via the user interface module 104 (e.g., a user operation on the node 802, or other user input, instructions, and/or commands from the user device 150 to the user interface module 104), the workflow visualization system 102 may display the “Email Review” software application via the user interface 1350 and juxtapose the user interface 1350 with the user interface 1300.

As shown in FIG. 13, the interactive graphical representation 1330 includes at least the node 802, the node 1004, and the node 912. The user interface 1350 includes a display portion 1302, a functional component 1312, a functional component 1304, a display portion 1342, and a display portion 1340. Here, the display portion 1302 reads “Email Review,” indicating what is displayed through the user interface 1350 is a user interface of the “Email Review” software application represented by the node 802 to allow users to operate the “Email Review” software application. The functional component 1312 reads “First Email,” indicating that the functional component 1312 is an email and corresponds to the “Email” data object type represented by the node 912. The functional component 1304 reads “Send Email,” indicating that the functional component 1304 corresponds to the “Send Email” action represented by the node 1004. The display portion 1342 shows a subject of the “First Email” and the display portion 1340 shows a body of the “First Email.” Here, the display portion 1342 reads “Subject: Product Launch Strategy and Action Items” and the display portion 1340 reads “body of the First Email that shows content of the First Email.”

In some implementations, when the user device 150 selects functional component 1312 (or the functional component 1304) in the user interface 1350, the workflow visualization system 102 may highlight the node 912 (or the node 1004) that represents the “Email” data object type to reflect the selection of the functional component 1312. Conversely, when the user device 150 selects the node 912 (or the node 1004) in the interactive graphical representation 1330 of the user interface 1300, the workflow visualization system 102 may highlight the functional component 1312 (or the functional component 1304) in the user interface 1350 to reflect the selection of the node 912. Advantageously, such unidirectional and/or bidirectional highlighting helps users to quickly identify and understand the connections between the software application's functional components shown in the user interface 1350 and their corresponding graphical representations shown in the interactive graphical representation 1330 of the user interface 1300.

### ADDITIONAL EXAMPLE IMPLEMENTATIONS AND DETAILS

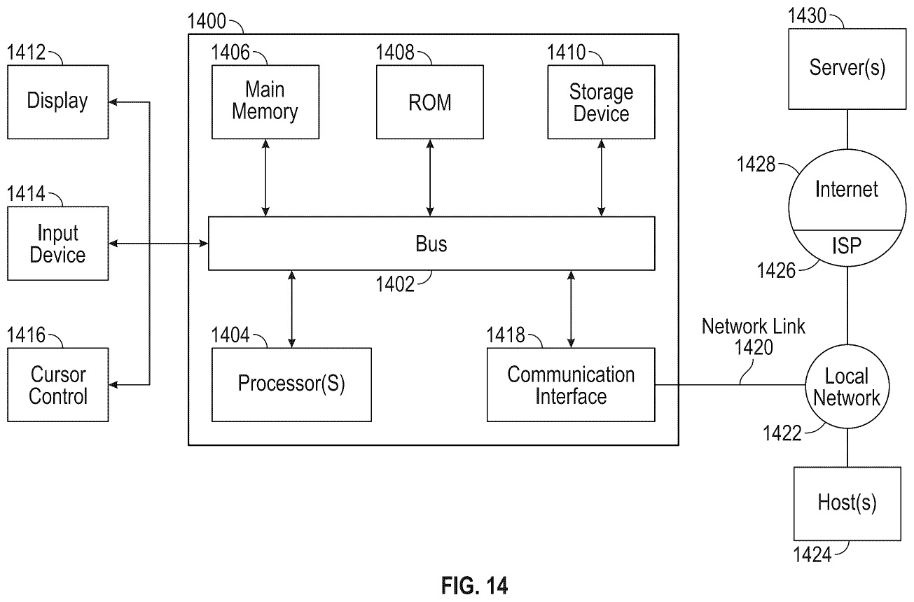

In an implementation of the system (e.g., one or more aspects of the workflow visualization system 102, one or more aspects of the computing environment 100, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 14) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In various implementations the virtual computing environment may comprise one or more virtual machines, containers, and/or other types of emulations of computing systems or environments. In various implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In various alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in various implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, Vx Works, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 14 shows a block diagram that illustrates a computer system 1400 upon which various implementations and/or aspects (e.g., one or more aspects of the computing environment 100, one or more aspects of the workflow visualization system 102, one or more aspects of the user device 150, one or more aspects of the data processing service 120, one or more aspects of the LLMs 130a and 130b, and/or the like) may be implemented. Multiple such computer systems 1400 may be used in various implementations of the present disclosure. Computer system 1400 includes a bus 1402 or other communication mechanism for communicating information, and a hardware processor, or multiple processors, 1004 coupled with bus 1402 for processing information. Hardware processor(s) 1404 may be, for example, one or more general purpose microprocessors.

Computer system 1400 also includes a main memory 1406, such as a random-access memory (RAM), cache and/or other dynamic storage devices, coupled to bus 1402 for storing information and instructions to be executed by processor 1404. Main memory 1406 also may be used for storing temporary variables or other intermediate information during execution of instructions to be executed by processor 1404. Such instructions, when stored in storage media accessible to processor 1404, render computer system 1400 into a special-purpose machine that is customized to perform the operations specified in the instructions. The main memory 1406 may, for example, include instructions to implement server instances, queuing modules, memory queues, storage queues, user interfaces, and/or other aspects of functionality of the present disclosure, according to various implementations.

Computer system 1400 further includes a read only memory (ROM) 1408 or other static storage device coupled to bus 1402 for storing static information and instructions for processor 1404. A storage device 1410, such as a magnetic disk, optical disk, or USB thumb drive (Flash drive), and/or the like, is provided and coupled to bus 1402 for storing information and instructions.

Computer system 1400 may be coupled via bus 1402 to a display 1412, such as a cathode ray tube (CRT) or LCD display (or touch screen), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computer system 1400 may include a user interface module to implement a GUI that may be stored in a mass storage device as computer executable program instructions that are executed by the computing device(s). Computer system 1400 may further, as described below, implement the techniques described herein using customized hard-wired logic, one or more ASICs or FPGAs, firmware and/or program logic which in combination with the computer system causes or programs computer system 1400 to be a special-purpose machine. According to one implementation, the techniques herein are performed by computer system 1400 in response to processor(s) 1404 executing one or more sequences of one or more computer-readable program instructions contained in main memory 1406. Such instructions may be read into main memory 1406 from another storage medium, such as storage device 1410. Execution of the sequences of instructions contained in main memory 1406 causes processor(s) 1404 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1404 for execution. For example, the instructions may initially be carried on a magnetic disk or solid-state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN (or WAN component to communicated with a WAN). Wireless links may also be implemented. In any such implementation, communication interface 1418 sends and receives electrical, electromagnetic, or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1026. ISP 1426 in turn provides data communication services through the worldwide packet data communication network now commonly referred to as the “Internet” 1028. Local network 1422 and Internet 1428 both use electrical, electromagnetic, or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### EXAMPLE CLAUSES

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.
Clause 1. A computerized method, performed by a computing system having one or more hardware computer processors and one or more non-transitory computer-readable storage devices storing software instructions executable by the computing system, the computerized method comprising: accessing one or more data stores that store a configuration of a software application, the configuration including information used for configuring the software application; determining, based on the configuration of the software application, that first one or more actions and first one or more data object types are associated with the software application; based at least on the first one or more actions and the first one or more data object types associated with the software application, generating an interactive graphical representation comprising a first node representing the software application, a first user interface element of the first node, and a second user interface element of the first node, wherein the first user interface element of the first node indicates that the first one or more data object types are associated with the software application, and wherein the second user interface element of the first node indicates that the first one or more actions are associated with the software application; and providing, via a first user interface, the interactive graphical representation.
Clause 2. The computerized method of Clause 1, further comprising: receiving a selection, made via the interactive graphical representation of the first user interface, of the first user interface element of the first node; and in response to receiving the selection of the first user interface element of the first node, providing at least, via the interactive graphical representation: a second node representing a first data object type of the first one or more data object types associated with the software application; and a first edge connecting the first node and the second node, the first edge representing that the software application reads a first data object of the first data object type, wherein the first edge directs from the second node to the first node.
Clause 3. The computerized method of Clause 2, wherein the interactive graphical representation comprises a first user interface element of the second node, the first user interface element of the second node indicating that the first data object type is associated with first one or more software applications.
Clause 4. The computerized method of Clause 3, further comprising: receiving a selection, made via the interactive graphical representation of the first user interface, of the first user interface element of the second node; and in response to receiving the selection of the first user interface element of the second node, providing at least, via the interactive graphical representation: first one or more nodes representing the first one or more software applications.
Clause 5. The computerized method of any of Clauses 2-4, wherein the interactive graphical representation comprises a second user interface element of the second node, the second user interface element of the second node indicating that the first data object type is associated with second one or more actions.
Clause 6. The computerized method of Clause 5, further comprising: receiving a selection, made via the interactive graphical representation of the first user interface, of the second user interface element of the second node; and in response to receiving the selection of the second user interface element of the second node, providing at least, via the interactive graphical representation: second one or more nodes representing the second one or more actions.
Clause 7. The computerized method of any of Clauses 2-6, further comprising: receiving a first user operation, made via the interactive graphical representation of the first user interface, on the second node; and in response to receiving the first user operation on the second node, providing via the interactive graphical representation: first one or more edges connecting the second node to third one or more nodes, the third one or more nodes representing second one or more data object types linked to the first data object type, wherein the first one or more edges represent at least one link type between the first data object type and the second one or more data object types.
Clause 8. The computerized method of any of Clauses 1-7, further comprising: receiving a selection, made via the interactive graphical representation of the first user interface, of the second user interface element of the first node; and in response to receiving the selection of the second user interface element of the first node, providing at least, via the interactive graphical representation: a third node representing a first action of the first one or more actions associated with the software application; and a second edge connecting the first node and the third node, the second edge representing that the software application performs the first action, wherein the second edge directs from the first node to the third node.
Clause 9. The computerized method of Clause 8, wherein the interactive graphical representation comprises a first user interface element of the third node, the first user interface element of the third node indicating that the first action is associated with second one or more software applications.
Clause 10. The computerized method of any of Clauses 8-9, wherein the interactive graphical representation comprises a second user interface element of the third node, the second user interface element of the third node indicating that the first action edits one or more data objects of third one or more data object types.
Clause 11. The computerized method of any of Clauses 8-10, further comprising: receiving a second user operation, made via the interactive graphical representation of the first user interface, on the third node; and in response to receiving the second user operation on the third node, providing via the interactive graphical representation: second one or more edges connecting the third node to fourth one or more nodes, the fourth one or more nodes representing one or more data objects of fourth one or more data object types read by the first action.
Clause 12. The computerized method of any of Clauses 8-10, further comprising: receiving a second user operation, made via the interactive graphical representation of the first user interface, on the third node; and in response to receiving the second user operation on the third node, providing via the interactive graphical representation: a fourth node representing an action log that records at least a timestamp and a user associated with a performance of the first action.
Clause 13. The computerized method of any of Clauses 8-10, further comprising: receiving a second user operation, made via the interactive graphical representation of the first user interface, on the third node; and in response to receiving the second user operation on the third node, providing an information panel via the first user interface, wherein the information panel comprises first information about input data used by the first action and second information about output data generated by the first action.
Clause 14. The computerized method of any of Clauses 8-10, further comprising: receiving a second user operation, made via the interactive graphical representation of the first user interface, on the third node; and in response to receiving the second user operation on the third node, using a large language model (“LLM”) to summarize function code used to implement one of the first one or more actions; and providing a summary panel via the first user interface, wherein the summary panel comprises a summary of the function code.
Clause 15. The computerized method of any of Clauses 8-14, wherein the interactive graphical representation comprises a second node representing a first data object type of the first one or more data object types associated with the software application, and wherein the second node and the third node are displayed according to a coloration scheme specifying that the second node and the third node are colored differently in the interactive graphical representation based on user permissions associated with the first data object type and the first action.
Clause 16. The computerized method of Clause 15, wherein, based on the user permissions, a first user is permitted to access a data object of the first data object type and unpermitted to execute the first action, and a second user is unpermitted to access the data object of the first data object type and permitted to execute the first action.
Clause 17. The computerized method of any of Clauses 1-16, wherein the first user interface element of the first node indicates a number of the first one or more data object types associated with the software application, and wherein the second user interface element of the first node indicates a number of the first one or more actions associated with the software application.
Clause 18. The computerized method of any of Clauses 1-17, wherein determining that the first one or more actions and the first one or more data object types are associated with the software application comprises: extracting, from the information included in the configuration of the software application, at least a widget, code, a variable, or a function used to configure the software application; and based on an ontology, parsing or traversing at least the widget, the code, the variable, or the function to identify the first one or more actions, the first one or more data object types, and lineage among the first one or more actions, the first one or more data object types, and the software application.
Clause 19. The computerized method of any of Clauses 1-17, wherein determining that the first one or more actions and the first one or more data object types are associated with the software application comprises: determining, based on an ontology, one or more properties of the first one or more data object types; and determining, based on the ontology, one or more link types between the first one or more data object types.
Clause 20. The computerized method of any of Clauses 18-19, wherein a scope of the interactive graphical representation of the first user interface is subject to at least the ontology, or a user's permission associated with the software application.
Clause 21. The computerized method of any of Clauses 2-20, further comprising: receiving a third user operation, made via the interactive graphical representation of the first user interface, on the first node; and responsive to the third user operation on the first node, causing display of the software application via a second user interface, the second user interface comprising a first functional component of the software application that corresponds to the first data object type, wherein the second user interface is in juxtaposition with the first user interface to form a split view of the first user interface and the second user interface.
Clause 22. The computerized method of Clause 21, further comprising: receiving a selection, made via the second user interface, of the first functional component of the software application; and responsive to the selection of the first functional component of the software application, highlighting the second node of the interactive graphical representation of the first user interface to reflect the selection of the first functional component.
Clause 23. The computerized method of Clause 21, further comprising: receiving a selection, made via the interactive graphical representation of the first user interface, of the second node; and responsive to the selection of the second node, highlighting the first functional component of the second user interface to reflect the selection of the second node.
Clause 24. The computerized method of any of Clauses 1-23, wherein the configuration of the software application is stored in the one or more data stores using a JavaScript Object Notation (“JSON”) format.
Clause 25. The computerized method of Clause 8, wherein the interactive graphical representation comprises a second node representing a first data object type of the first one or more data object types associated with the software application, and wherein the interactive graphical representation further comprises a third edge connecting the third node and the second node, the third edge representing that the first action edits at least a first data object of the first data object type, wherein the third edge directs from the third node to the second node.
Clause 26. A system comprising: one or more computer-readable storage mediums having program instructions embodied therewith; and one or more processors configured to execute the program instructions to cause the system to perform the computerized method of any of Clauses 1-25.
Clause 27. A computer program product comprising one or more computer-readable storage mediums having program instructions embodied therewith, the program instructions executable by one or more processors to cause the one or more processors to perform the computerized method of any of Clauses 1-25.

What is claimed is:

1. A computerized method, performed by a computing system having one or more hardware computer processors and one or more non-transitory computer-readable storage devices storing software instructions executable by the computing system, the computerized method comprising:
accessing one or more data stores that store a configuration of a software application, the configuration including information used for configuring the software application;
determining, based on the configuration of the software application, that first one or more actions and first one or more data object types are associated with the software application;
based at least on the first one or more actions and the first one or more data object types associated with the software application, generating an interactive graphical representation comprising a first node representing the software application, a first user interface element of the first node, and a second user interface element of the first node, wherein the first user interface element of the first node indicates that the first one or more data object types are associated with the software application, and wherein the second user interface element of the first node indicates that the first one or more actions are associated with the software application; and
providing, via a first user interface, the interactive graphical representation.

2. The computerized method of claim 1, further comprising:
receiving a selection, made via the interactive graphical representation of the first user interface, of the first user interface element of the first node; and
in response to receiving the selection of the first user interface element of the first node, providing at least, via the interactive graphical representation:
a second node representing a first data object type of the first one or more data object types associated with the software application; and
a first edge connecting the first node and the second node, the first edge representing that the software application reads a first data object of the first data object type, wherein the first edge directs from the second node to the first node.

3. The computerized method of claim 2, wherein the interactive graphical representation comprises a first user interface element of the second node, the first user interface element of the second node indicating that the first data object type is associated with first one or more software applications.

4. The computerized method of claim 3, further comprising:
receiving a selection, made via the interactive graphical representation of the first user interface, of the first user interface element of the second node; and
in response to receiving the selection of the first user interface element of the second node, providing at least, via the interactive graphical representation:
first one or more nodes representing the first one or more software applications.

5. The computerized method of claim 2, wherein the interactive graphical representation comprises a second user interface element of the second node, the second user interface element of the second node indicating that the first data object type is associated with second one or more actions.

6. The computerized method of claim 5, further comprising:
receiving a selection, made via the interactive graphical representation of the first user interface, of the second user interface element of the second node; and
in response to receiving the selection of the second user interface element of the second node, providing at least, via the interactive graphical representation:
second one or more nodes representing the second one or more actions.

7. The computerized method of claim 2, further comprising:
receiving a first user operation, made via the interactive graphical representation of the first user interface, on the second node; and
in response to receiving the first user operation on the second node, providing via the interactive graphical representation:
first one or more edges connecting the second node to third one or more nodes, the third one or more nodes representing second one or more data object types linked to the first data object type, wherein the first one or more edges represent at least one link type between the first data object type and the second one or more data object types.

8. The computerized method of claim 2, further comprising:
receiving a third user operation, made via the interactive graphical representation of the first user interface, on the first node; and
responsive to the third user operation on the first node, causing display of the software application via a second user interface, the second user interface comprising a first functional component of the software application that corresponds to the first data object type,
wherein the second user interface is in juxtaposition with the first user interface to form a split view of the first user interface and the second user interface.

9. The computerized method of claim 8, further comprising:
receiving a selection, made via the second user interface, of the first functional component of the software application; and
responsive to the selection of the first functional component of the software application, highlighting the second node of the interactive graphical representation of the first user interface to reflect the selection of the first functional component.

10. The computerized method of claim 8, further comprising:
receiving a selection, made via the interactive graphical representation of the first user interface, of the second node; and
responsive to the selection of the second node, highlighting the first functional component of the second user interface to reflect the selection of the second node.

11. The computerized method of claim 1, further comprising:
receiving a selection, made via the interactive graphical representation of the first user interface, of the second user interface element of the first node; and
in response to receiving the selection of the second user interface element of the first node, providing at least, via the interactive graphical representation:
a third node representing a first action of the first one or more actions associated with the software application; and
a second edge connecting the first node and the third node, the second edge representing that the software application performs the first action, wherein the second edge directs from the first node to the third node.

12. The computerized method of claim 11, wherein the interactive graphical representation comprises at least one of:
a first user interface element of the third node, the first user interface element of the third node indicating that the first action is associated with second one or more software applications; or
a second user interface element of the third node, the second user interface element of the third node indicating that the first action edits one or more data objects of third one or more data object types.

13. The computerized method of claim 11, further comprising:
receiving a second user operation, made via the interactive graphical representation of the first user interface, on the third node; and
in response to receiving the second user operation on the third node, at least one of:
providing, via the interactive graphical representation, second one or more edges connecting the third node to fourth one or more nodes, the fourth one or more nodes representing one or more data objects of fourth one or more data object types read by the first action;
providing, via the interactive graphical representation, a fourth node representing an action log that records at least a timestamp and a user associated with a performance of the first action;
providing an information panel via the first user interface, wherein the information panel comprises first information about input data used by the first action and second information about output data generated by the first action; or
using a large language model (“LLM”) to summarize function code used to implement one of the first one or more actions; and providing a summary panel via the first user interface, wherein the summary panel comprises a summary of the function code.

14. The computerized method of claim 11, wherein the interactive graphical representation comprises a second node representing a first data object type of the first one or more data object types associated with the software application, wherein the second node and the third node are displayed according to a coloration scheme specifying that the second node and the third node are colored differently in the interactive graphical representation based on user permissions associated with the first data object type and the first action, and wherein, based on the user permissions, a first user is permitted to access a data object of the first data object type and unpermitted to execute the first action, and a second user is unpermitted to access the data object of the first data object type and permitted to execute the first action.

15. The computerized method of claim 11, wherein the interactive graphical representation comprises a second node representing a first data object type of the first one or more data object types associated with the software application, and wherein the interactive graphical representation further comprises a third edge connecting the third node and the second node, the third edge representing that the first action edits at least a first data object of the first data object type, wherein the third edge directs from the third node to the second node.

16. The computerized method of claim 1, wherein the first user interface element of the first node indicates a number of the first one or more data object types associated with the software application, and wherein the second user interface element of the first node indicates a number of the first one or more actions associated with the software application.

17. The computerized method of claim 1, wherein determining that the first one or more actions and the first one or more data object types are associated with the software application comprises:
extracting, from the information included in the configuration of the software application, at least a widget, code, a variable, or a function used to configure the software application; and
based on an ontology, parsing or traversing at least the widget, the code, the variable, or the function to identify the first one or more actions, the first one or more data object types, and lineage among the first one or more actions, the first one or more data object types, and the software application;
wherein a scope of the interactive graphical representation of the first user interface is subject to at least the ontology, or a user's permission associated with the software application.

18. The computerized method of claim 1, wherein determining that the first one or more actions and the first one or more data object types are associated with the software application comprises:
determining, based on an ontology, one or more properties of the first one or more data object types; and
determining, based on the ontology, one or more link types between the first one or more data object types;
wherein a scope of the interactive graphical representation of the first user interface is subject to at least the ontology, or a user's permission associated with the software application.

19. A system comprising:
one or more computer-readable storage mediums having program instructions embodied therewith; and
one or more processors configured to execute the program instructions to cause the system to perform the computerized method of claim 1.

20. A computer program product comprising one or more computer-readable storage mediums having program instructions embodied therewith, the program instructions executable by one or more processors to cause the one or more processors to perform the computerized method of any of claim 1.
